(19) United States
(12) Patent Application Publication
(10) Pub. No.: US 2025/0172022 A1
(43) Pub. Date: May 29, 2025

(54) LID OPENING AND CLOSING DEVICE

(71) Applicant: U-Shin Ltd., Nagano (JP)

(72) Inventor: Yuki TANAKA, Hiroshima (JP)

(21) Appl. No.: 18/842,439

(22) PCT Filed: Jan. 11, 2023
(86) PCT No.: PCT/JP2023/000384

§ 371 Date: Aug. 29, 2024

(30) Foreign Application Priority Data
Mar. 1, 2022 (JP) 2022-031238

(51) Int. Cl. E05B 83/34; B60L 53/16; E05B 81/06; E05B 81/16; E05B 81/30; E05B 81/42; E05F 15/63

(52) U.S. Cl. CPC E05B 83/34; E05B 81/16; E05B 81/30; E05B 81/42; E05F 15/63; B60L 53/16; E05B 81/06; E05Y 2201/224; E05Y 2201/638; E05Y 2900/534

(57) ABSTRACT

A lid opening and closing device includes a base, a lid, an arm that has a pivoting part and an engagement portion and is movable between a retracted position and an advanced position, a rotating body that moves the arm by a driving force received from a drive source, a locking member that is rotatable between a lock position and an unlock position when the arm is in the retracted position, a cam that rotates the locking member toward the unlock position when the arm is moved to the advanced position, and a differential mechanism that starts rotating the pivoting part after a delay from the start of rotation of the rotating body when the arm is moved to the advanced position.

### TECHNICAL FIELD

The present invention relates to a lid opening and closing device.

### BACKGROUND ART

Patent Documents 1 and 2 disclose lid opening and closing devices used for electric vehicles. The lid opening and closing device of Patent Document 1 includes a motor for automatically opening and closing a lid. The lid opening and closing device of Patent Document 2 includes a lock mechanism including an actuator for advancing and retracting a lock pin, for locking a lid, between a lock position and an unlock position.

### PRIOR ART DOCUMENTS

### Patent Documents

Patent Document 1: JP 2014-210473 A

Patent Document 2: JP 2011-240753 A

### SUMMARY OF THE INVENTION

### Problems to be Solved by the Invention

The lid opening and closing device of Patent Document 1 still has room for improvement in terms of security, since a lid in a closed state cannot be locked to disallow opening of the lid. Security can be improved by applying the lock mechanism of Patent Document 2 to the lid opening and closing device of Patent Literature 1. In this case, two drive sources are necessary for opening and closing the lid and for locking the lid. This increases the manufacturing cost of the lid opening and closing device.

An object of the present invention is to provide a lid opening and closing device that can automatically open and close a lid and lock the lid with a suppressed increase in cost.

### Solutions to the Problems

The present invention provides a lid opening and closing device including a base disposed in an inner side of a receiving port of a panel, a lid that openably close the receiving port, an arm including a pivoting part on one end side of the arm and pivotally supported by the base, a continuous portion on another end side continuous with the lid, and an engagement portion provided to the pivoting part, the arm being movable between a retracted position where the arm is retracted within the panel to close the receiving port by the lid and an advanced position where the arm is protruding out through the panel to open the receiving port, a rotating body that transmits a driving force received from a drive source to the pivoting part to move the arm between the retracted position and the advanced position, a locking member pivotally supported by the base to be adjacent to the pivoting part, the locking member being rotatable about a rotation axis extending along a rotation axis of the pivoting part between a lock position in which the locking member is engaged with the engagement portion and an unlock position in which the locking member is disengaged from the engagement portion when the arm is in the retracted position, a cam that is rotatable in conjunction with the rotating body and transmits a rotational force of the rotating body to rotate the locking member in the lock position toward the unlock position when the arm in the retracted position is moved to the advanced position, and a differential mechanism that starts rotation of the pivoting part after a delay from start of rotation of the rotating body when the arm in the retracted position is moved to the advanced position.

The lid can be automatically opened and closed via the arm since there is provided the rotating body that transmits the driving force of the drive source to the pivoting part to move the arm to the retracted position and the advanced position. In addition, there is provided the locking member rotatable between the lock position where the locking member is engaging with the engagement portion of the pivoting part and the unlock position where the locking member is disengaged from the engagement portion when the arm is in the retracted position, so that the lid in the closed state can be locked via the arm. Furthermore, there is provided the cam that transmits the rotational force of the rotating body to rotate the locking member in the lock position toward the unlock position when the arm in the retracted position is moved toward the advanced position, so that locking by the locking member can be cancelled in the opening operation of the lid. As described above, since automatic opening and closing of the lid and locking of the lid by the locking member can both be performed by a single drive source, an increase in size and cost of the lid opening and closing device is suppressed and at the same time security can be improved as compared with the case where two drive sources are mounted.

### Effects of the Invention

In the present invention, automatic opening and closing and locking of a lid can be performed and at the same time the increase in cost can be suppressed.

### BRIEF DESCRIPTION OF THE DRAWINGS

FIG. 1 is a perspective view of a lid opening and closing device according to an embodiment of the present invention.

FIG. 2 is a plan view of the lid opening and closing device in an open state.

FIG. 3 is a plan view of the lid opening and closing device in a closed state.

FIG. 4 is an exploded perspective view of the lid opening and closing device as viewed from the back side.

FIG. 5 is an exploded perspective view of a bearing unit.

FIG. 6 is a cross-sectional view taken along line VI-VI in FIG. 3.

FIG. 7 is a cross-sectional view taken along line VII-VII in FIG. 3.

FIG. 8 is a cross-sectional view taken along line VIII-VIII in FIG. 7.

FIG. 9 is a cross-sectional view taken along line IX-IX in FIG. 7.

FIG. 10 is an exploded perspective view of a spindle, an input cam, and a lock pin.

FIG. 11 is an exploded perspective view of the spindle, the input cam, and the lock pin as viewed from a direction different from that of FIG. 10.

FIG. 12 is a plan view of the spindle.

FIG. 13 is a plan view of the lock pin.

FIG. 14 is a plan view of the input cam.

FIG. 15 is a chart showing the movement of the input cam, the spindle, and the lock pin in an opening operation of a lid.

FIG. 16 is a chart showing the movement of the input cam, the spindle, and the lock pin in a closing operation of the lid.

FIG. 17A is a cross-sectional view similar to FIG. 8 and illustrating a first state in a lid opening operation.

FIG. 17B is a cross-sectional view similar to FIG. 9 and illustrating the first state in the lid opening operation.

FIG. 18A is a cross-sectional view similar to FIG. 8 and illustrating a second state in the lid opening operation.

FIG. 18B is a cross-sectional view similar to FIG. 9 and illustrating the second state in the lid opening operation.

FIG. 19A is a cross-sectional view similar to FIG. 8 and illustrating a third state in the lid opening operation.

FIG. 19B is a cross-sectional view similar to FIG. 9 and illustrating the third state in the lid opening operation.

FIG. 20A is a cross-sectional view similar to FIG. 8 and illustrating an open state of the lid.

FIG. 20B is a cross-sectional view similar to FIG. 9 and illustrating the open state of the lid.

FIG. 21A is a cross-sectional view similar to FIG. 8 and illustrating a first state in a lid closing operation.

FIG. 21B is a cross-sectional view similar to FIG. 9 and illustrating the first state in the lid closing operation.

FIG. 22A is a cross-sectional view similar to FIG. 8 and illustrating a second state in the lid closing operation.

FIG. 22B is a cross-sectional view similar to FIG. 9 and illustrating the second state in the lid closing operation.

### DETAILED DESCRIPTION

Hereinafter, embodiments of the present invention will be described with reference to the drawings.

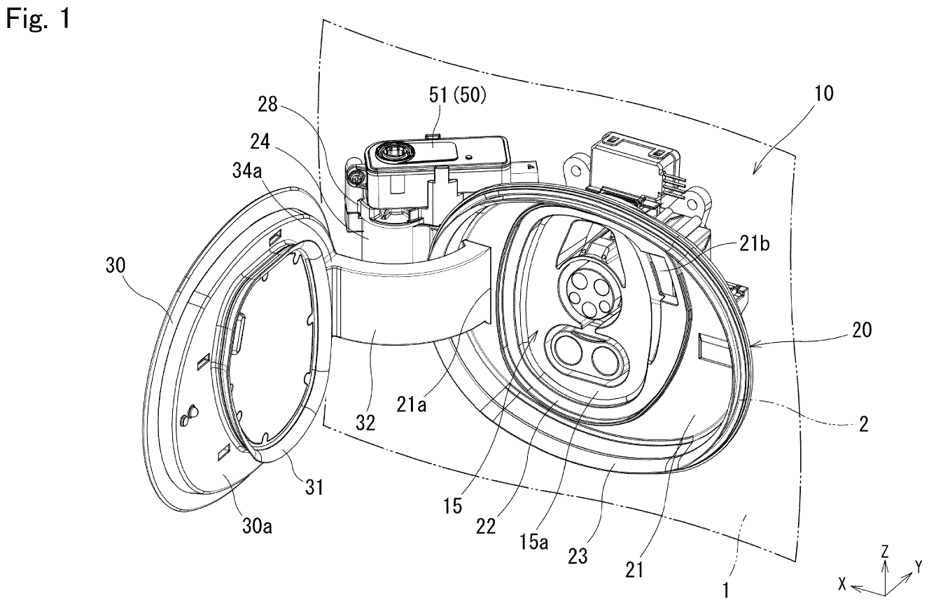

FIG. 1 illustrates a lid opening and closing device 10 according to an embodiment of the present invention. The lid opening and closing device 10 includes a power supply connector (receiving unit) 15 to which a charging plug (not illustrated) is connected, and is mounted on a side panel (panel) 1 of a car. The receiving unit may be for supplying any of a liquid fuel such as gasoline and light oil, and a gaseous fuel such as hydrogen and LP gas.

X direction in the drawings is a vehicle length direction of the car, Y direction is a vehicle width direction of the car, and Z direction is a vehicle height direction of the car. In each drawing, an arrow in the X direction indicates the front side, and the side opposite to the side indicated by the arrow is the rear side. An arrow in the Y direction indicates the vehicle interior side (inner side), and the side opposite to the side indicated by the arrow is the vehicle exterior side (outer side). An arrow in the Z direction indicates the upper side, and the side opposite to the side indicated by the arrow is the lower side.

Referring to FIG. 1, the side panel 1 is provided with a receiving port 2 passing through the side panel 1 in the vehicle width direction Y. The shape of the receiving port 2 as viewed in the vehicle width direction Y is substantially elliptical in the present embodiment, but can vary as necessary.

Referring to FIGS. 1 to 3, the lid opening and closing device 10 includes a base 20 mounted on the inner side of the side panel 1 in the vehicle width direction Y, and a lid 30 that openably closes the receiving port 2. The lid 30 includes an arm 32 of which one end is pivotally supported by the base 20. The arm 32 includes an arm body 33 including a first arm 34 and a second arm 35, and a spindle 37 constituting a part of a pivoting part 36.

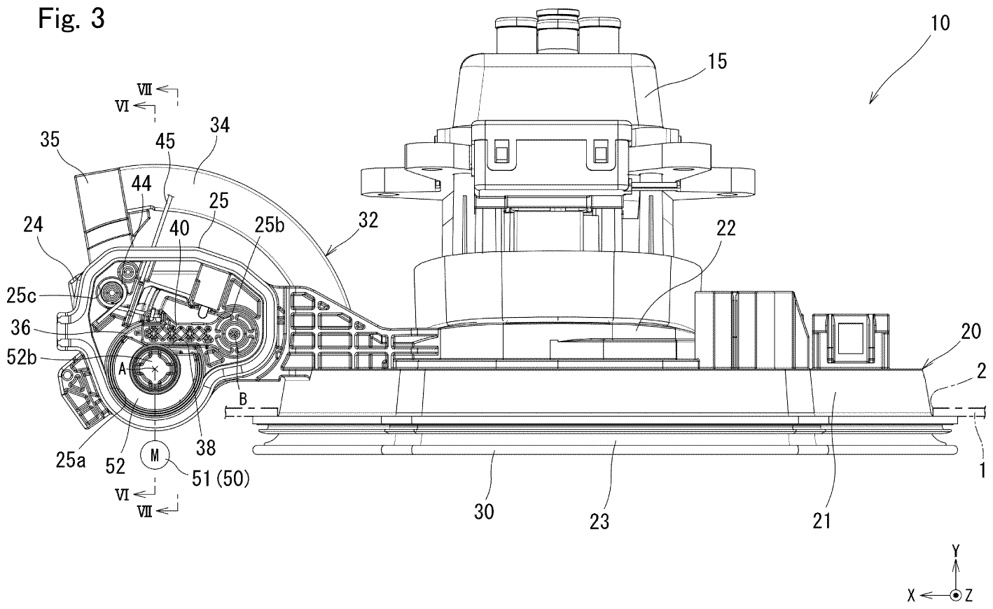

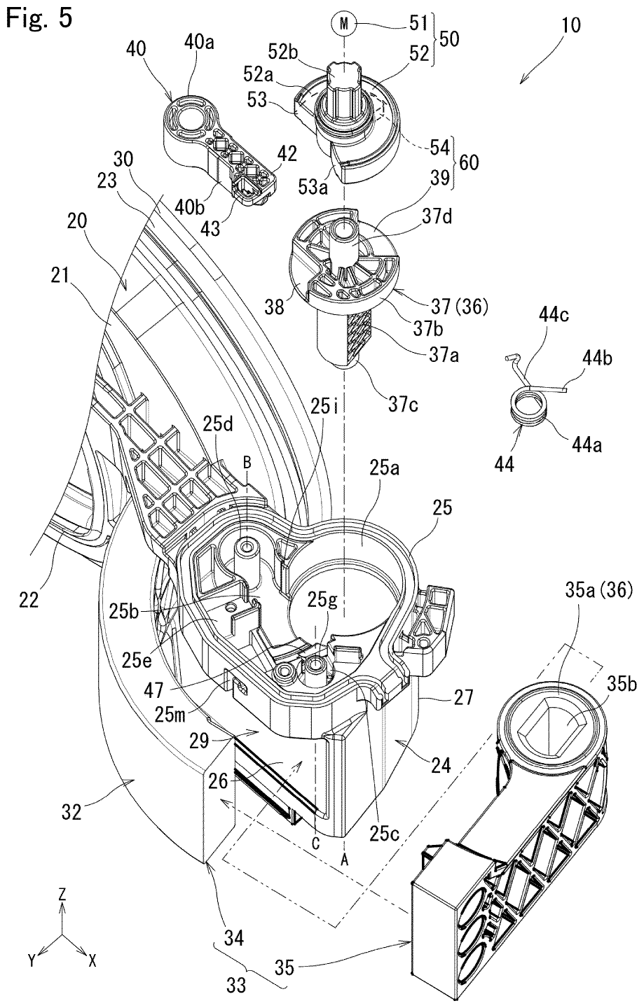

The lid opening and closing device 10 further includes a lock pin (locking member) 40 that locks the arm 32 in a state where the lid 30 has rotated to a closed position illustrated in FIG. 3, a torsion spring (biasing member) 44, and a drive mechanism 50 that moves the arm 32 and the lock pin 40. The drive mechanism 50 includes a motor (drive source) 51 and an input cam 52 having a cam surface (cam) 53a. Referring to FIG. 5, the drive mechanism 50 of the present embodiment includes a differential mechanism 60 that transmits the driving force to the spindle 37 to open and close the lid 30. When rotating the lid 30 in the closed position to an open position, the differential mechanism 60 delays the rotation of the spindle 37 from the start of rotation of the lock pin 40.

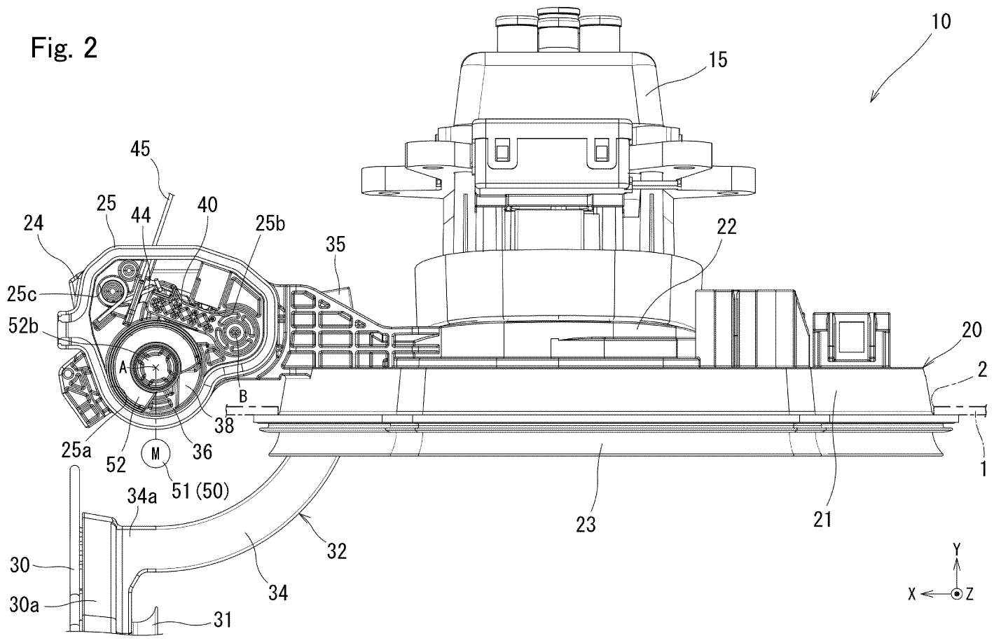

The arm 32 is rotated via the differential mechanism 60 by the drive mechanism 50 between an advanced position illustrated in FIG. 2 where the arm 32 is protruding out of the side panel 1 and a retracted position illustrated in FIG. 3 in which the arm 32 is retracted within the side panel 1. The lid 30 is in a position opening the receiving port 2 (open position) when the arm 32 has rotated to the advanced position as illustrated in FIG. 2, and is in a position closing the receiving port 2 (closed position) when the arm 32 has rotated to the retracted position as illustrated in FIG. 3. Further, the drive mechanism 50 rotates (moves) the lock pin 40 from a lock position illustrated in FIG. 3 to an unlock position illustrated in FIG. 2. The differential mechanism 60 causes the arm 32 to start rotating after a delay from the start of the movement of the lock pin 40 from the lock position toward the unlock position. The lock pin 40 in the unlock position illustrated in FIG. 2 is biased toward the lock position illustrated in FIG. 3 by the torsion spring 44.

Next, the base 20, the lid 30, the arm 32, the lock pin 40, the torsion spring 44, the drive mechanism 50, and the differential mechanism 60 will be specifically described.

In the following description, rotation of the lid 30 along with rotation of the arm 32 made by the drive mechanism 50 may be simply referred to as rotation of the lid 30 by the drive mechanism 50. Locking or unlocking of the arm 32 by the lock pin 40 may be referred to as locking or unlocking of the lid 30 by the lock pin 40.

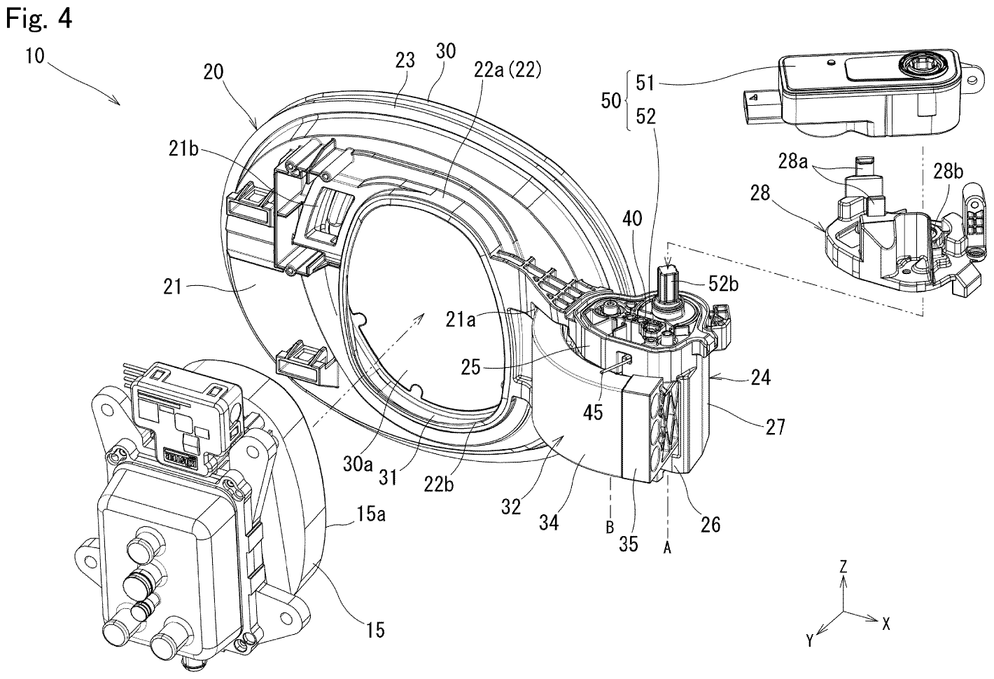

Referring to FIGS. 1 and 4, the base 20 includes a base body 21 that closes the receiving port 2 and a bearing unit 24 that pivotally supports the arm 32.

The base body 21 is provided with a mounting portion 22 for mounting a power supply connector 15. A sealing member 23 for sealing between the lid 30 in the closed position and the base body 21 is attached to the base body 21.

Referring to FIG. 4, the mounting portion 22 includes a recessed portion 22a recessed in the inner side in the vehicle width direction Y, and a mounting port 22b is formed at the bottom of the recessed portion 22a. The power supply connector 15 is mounted to the mounting port 22b from the inner side in the vehicle width direction Y. Thus, as illustrated in FIG. 1, the connecting portion 15a of the power supply connector 15 is positioned in the inner side of the receiving port 2, and is exposed to the outside of the vehicle through the receiving port 2 when the lid 30 is in the open state.

Referring to FIG. 1, the sealing member 23 has a ring shape corresponding to the shape of the receiving port 2, and is attached to the outer circumferential edge of the base body 21. The sealing member 23 protrudes outward in the vehicle width direction Y from the base body 21 toward the receiving port 2, and makes a pressure contact with the lid 30 in the closed position illustrated in FIG. 3 to water-tightly seal between the base body 21 and the lid 30. The sealing member 23 does not make a pressure contact with the lid 30 in the. open position illustrated in FIG. 2.

Referring to FIGS. 1 and 4, the base body 21 is further provided with an insertion hole 21a through which the arm 32 is disposed so as to advance and retract, and an opening 21b in which a switch (not illustrated) is disposed. The insertion hole 21a and the opening 21b are located within the receiving port 2 as viewed in the vehicle width direction Y.

Referring to FIG. 4, the bearing unit 24 has a structure integral with the base body 21, and is adjacent to and in the front side in the vehicle length direction X of the mounting portion 22 to be located in the inner side in the vehicle width direction Y. The bearing unit 24 includes an end wall part 25 located on the upper side in FIG. 4, an end wall part 26 located on the lower side in FIG. 4, and a side wall part 27 connecting the end wall parts 25 and 26. The end wall parts 25 and 26 are provided with a gap therebetween in the vehicle height direction Z, and both extend in an XY plane. The end wall part 25 is on the upper side of the insertion hole 21a to extend in the inner side in the vehicle width direction Y, and the end wall part 26 is on the lower side of the insertion hole 21a to extend in the inner side in the vehicle width direction Y. The side wall part 27 covers between front ends, in the vehicle length direction X, and outer ends, in the vehicle width direction Y, of the end wall parts 25 and 26. Between rear ends, in the vehicle length direction X, and between inner ends, in the vehicle width direction Y, of the end wall parts 25 and 26 are opened, so there is a gap between the end wall parts 25 and 26.

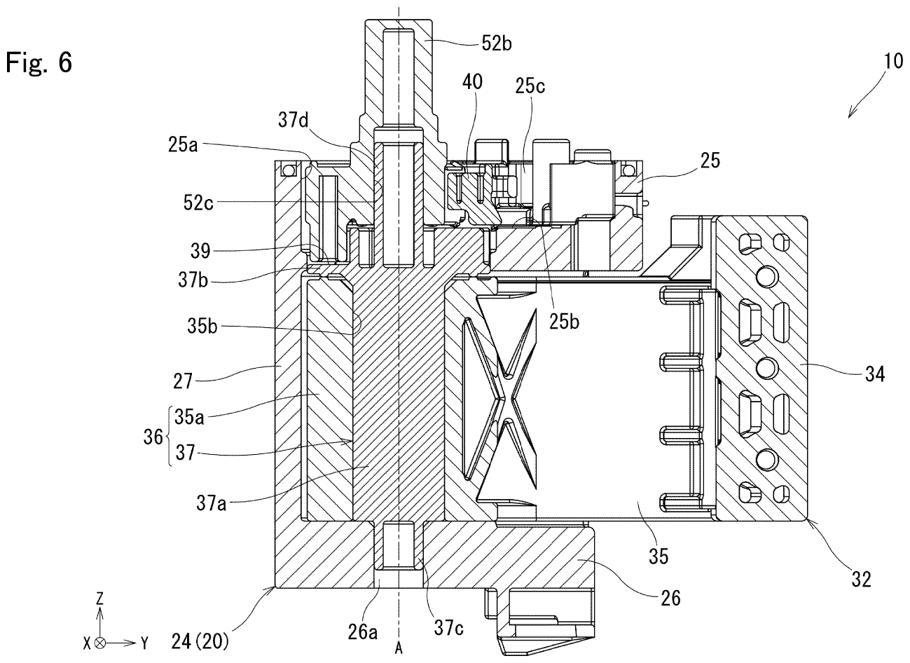

Referring to FIGS. 5 and 6, the end wall part 25 is provided with a first set portion 25a in which the input cam 52 of the drive mechanism 50 is rotatably disposed, a second set portion 25b in which the lock pin 40 is rotatably disposed, and a third set portion 25c in which the torsion spring 44 is disposed. Note that specific configurations of the set portions 25a to 25c will be described later in detail.

Referring to FIGS. 1 and 4, the upper ends of the first set portion 25a to the third set portion 25c are covered by a cover 28. The lock pin 40, the torsion spring 44, and the input cam 52 are accommodated in the cover 28. A mounting piece 28a for mounting the motor 51 of the drive mechanism 50 protrudes out of the cover 28. The cover 28 is provided with a through hole 28b for connecting the motor 51 in the outer side to the input cam 52 in the inner side.

Referring to FIGS. 1 and 3, the lid 30 has a plate-shaped smaller than the receiving port 2 but larger than the sealing member 23. The lid 30 is rotatable with respect to the base 20 by the arm 32 pivotally supported by the bearing unit 24 to openably close the receiving port 2. The lid 30 includes a protruding portion 30a that, when the lid 30 is in the closed state illustrated in FIG. 3, is positioned within the sealing member 23 and protrudes toward the base body 21. A sealing member 31 that makes pressure contact with the base body 21 is attached to the protruding portion 30a.

The arm 32 extends from the inside to the outside in the vehicle width direction Y of the base 20 through the insertion hole 21a. Referring to FIGS. 5 and 6, the arm 32 includes a pivoting part 36 pivotally supported by the bearing unit 24. In more detail, the arm 32 includes the arm body 33 including the first arm 34 and the second arm 35, and the spindle 37 constituting a part of the pivoting part 36.

Referring to FIGS. 1 to 3, the first arm 34 has an arc shape extending in the circumferential direction around a rotation axis A of the pivoting part 36, and is inserted through the insertion hole 21a. The first arm 34 includes, at a distal end (the other end of the arm 32) on the outer side in the vehicle width direction Y, a continuous portion 34a continuous with the protruding portion 30a of the lid 30.

Referring to FIGS. 5 and 6, the second arm 35 has a plank shape, is inserted into the gap between the end wall parts 25 and 26, and protrudes in the inner side in the vehicle width direction Y from the bearing unit 24. The first arm 34 is mechanically connected to an inner end, in the vehicle width direction Y, of the second arm 35. A sleeve portion 35a is formed at an outer end (one end of the arm 32), in the vehicle width direction Y, of the second arm 35. The spindle 37 is attached to the sleeve portion 35a. The sleeve portion 35a and the spindle 37 constitute a pivoting part 36.

The sleeve portion 35a is provided with a non-circular mounting hole 35b passing through the sleeve portion 35a in the vehicle height direction Z. The axis of the mounting hole 35b is the rotation axis A of the pivoting part 36.

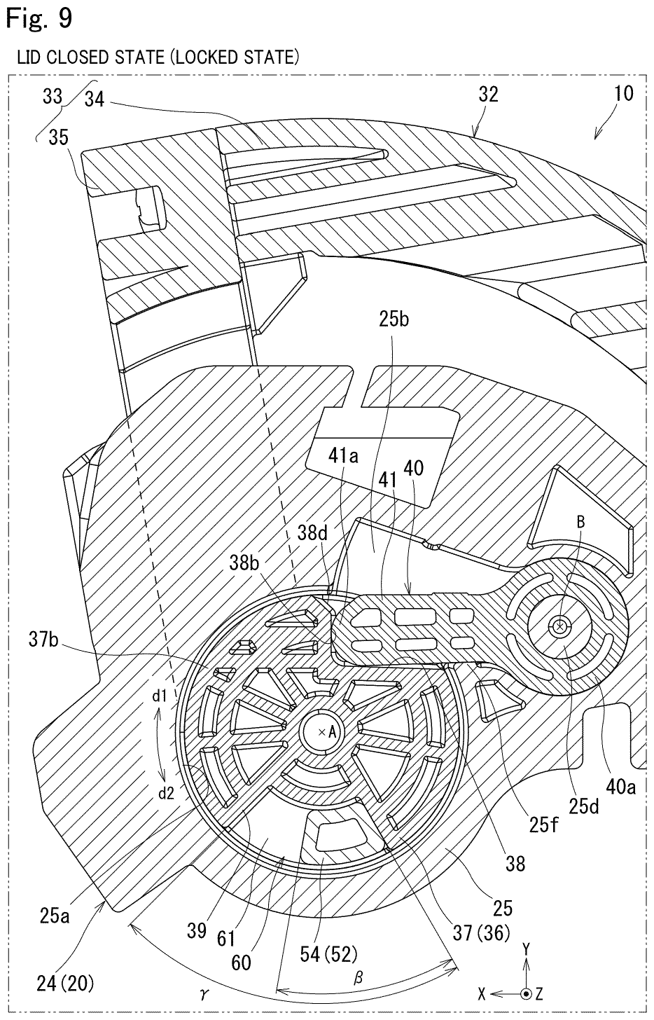

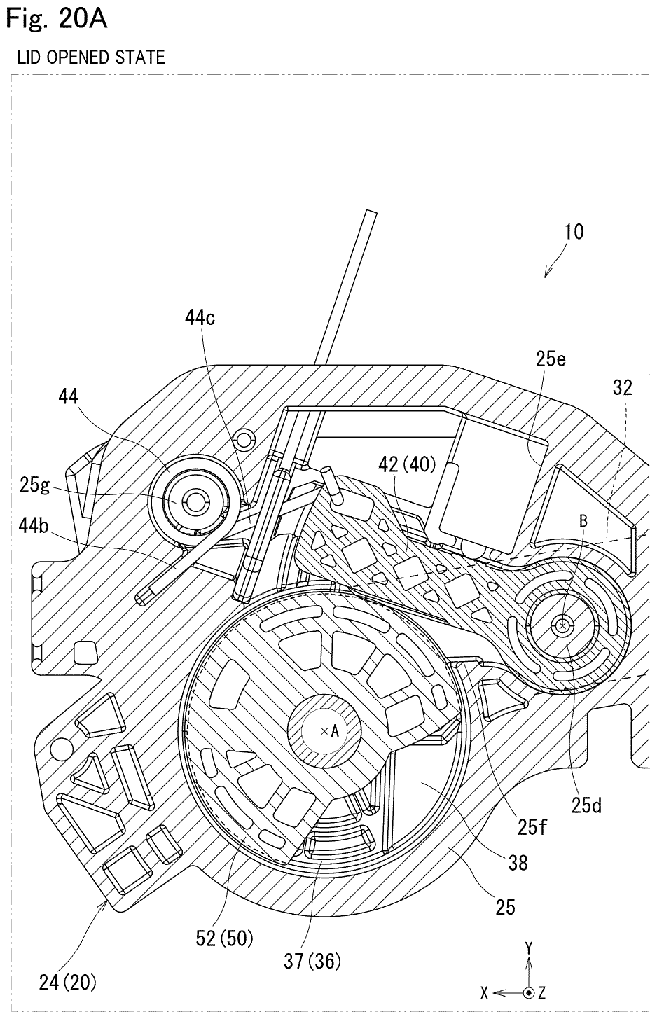

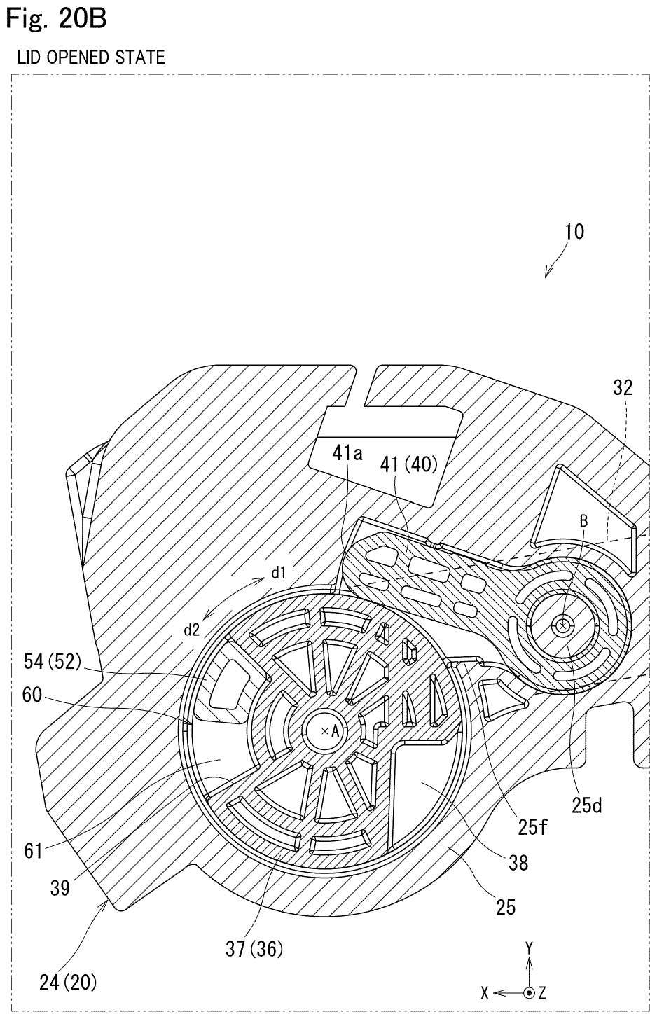

Referring to FIGS. 5 and 6, the spindle 37 includes a mounting portion 37a, a flange 37b, and a shaft 37c. Referring to FIGS. 9 and 20B, the drive mechanism 50 rotates the spindle 37 in direction d1 to open-rotate the arm 32 in the retracted position illustrated in FIG. 3 to the advanced position illustrated in FIG. 2 and in direction d2 to close-rotate the arm 32 in the advanced position illustrated in FIG. 2 to the retracted position illustrated in FIG. 3.

The spindle 37 is attached by being inserted into the first set portion 25a of the pivotal attachment unit 24 from the upper side in the vehicle height direction Z. The first set portion 25a is a circular through hole passing through the end wall part 25 in the vehicle height direction Z.

The mounting portion 37a generally has a rod shape, and has a non-circular cross-sectional shape corresponding to the cross-sectional shape of the mounting hole 35b. With the mounting portion 37a mounted in the mounting hole 35b, the spindle 37 and the sleeve portion 35a rotate integrally.

The flange 37b is continuous with the upper end of the mounting portion 37a and is located on the upper side, in the vehicle height direction Z, of the sleeve portion 35a. The flange 37b has a circular shape having the same diameter as the diameter of the sleeve portion 35a as viewed from the extending direction of the rotation axis A of the pivoting part 36, and is rotatably supported by a hole wall in the first set portion 25a of the end wall part 25. The flange 37b of the spindle 37 attached to the bearing unit 24 closes the bottom of the through hole which is the first set portion 25a. The shaft 37d having an axis coincident with the rotation axis A and pivotally supporting the input cam 52 protrudes at the center of the flange 37b. The flange 37b is further provided with an engagement groove (engagement portion) 38 that engages with the lock pin 40, and a recessed portion 39 constituting the differential mechanism 60. The engagement groove 38 and the recessed portion 39 will be described in detail later.

The shaft 37c is provided at the lower end of the mounting portion 37a and protrudes from the sleeve portion 35a to the lower side in the vehicle height direction Z. By attaching the spindle 37 to the bearing unit 24, the shaft 37c is disposed in a shaft hole 26a of the end wall part 26. The shaft hole 26a is correspondingly provided on the lower side of the first set portion 25a in the vehicle height direction Z. The spindle 37 is rotatably supported by the bearing unit 24 by the shaft 37c disposed in the shaft hole 26a and the flange 37b disposed in the first set portion 25a.

Referring to FIGS. 5, 10, and 11, the lock pin 40 includes a sleeve portion 40a and a lock pin body 40b. When the arm 32 is in the retracted position, the lock pin 40 is movable between the lock position illustrated in FIG. 3 and the unlock position illustrated in FIG. 2. Referring to FIG. 9, the lock pin 40 in the lock position is engaging with the engagement groove 38 of the spindle 37. Referring to FIG. 20B, the lock pin 40 in the unlock position is disengaged from the engagement groove 38.

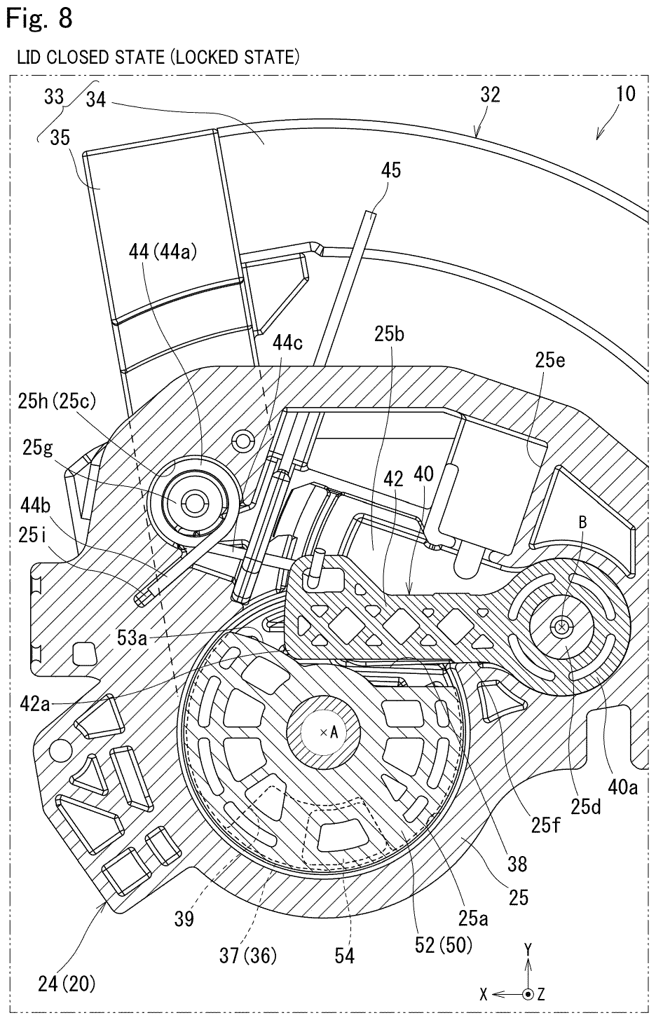

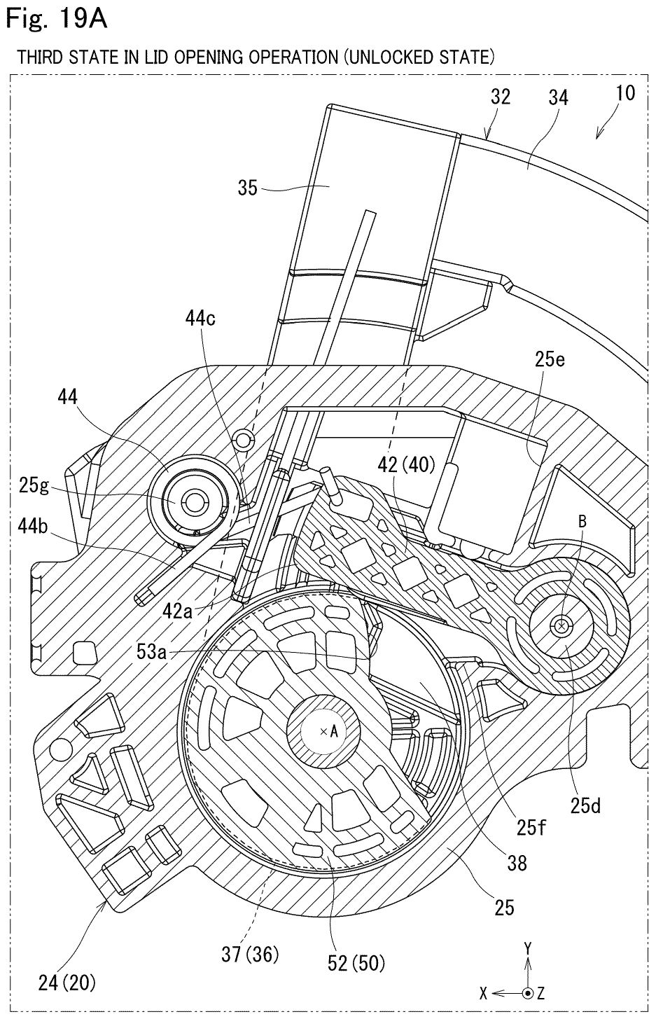

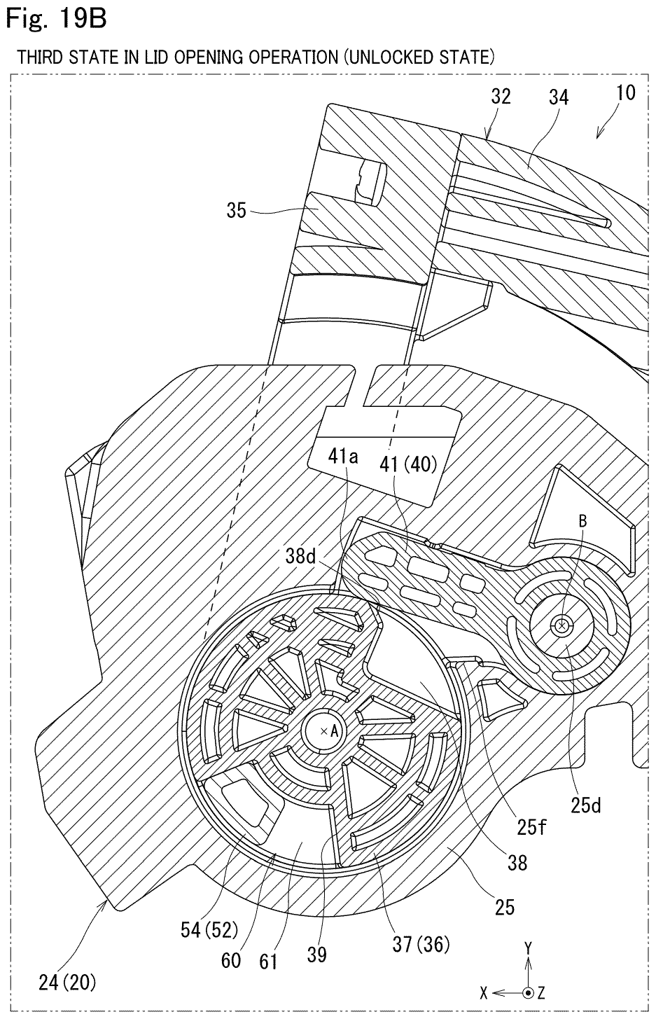

Referring to FIG. 8, the lock pin 40 is biased by the torsion spring 44 from the unlock position illustrated in FIG. 19B toward the lock position illustrated in FIG. 9. The rotation of the lock pin 40 by the biasing force of the torsion spring 44 is stopped by the lock pin 40 abutting the stopper 25f. The stopper 25f is a part of a partition wall between the first set portion 25a and the second set portion 25b, and restricts the lock pin 40 rotating beyond the lock position. Reference 45 in FIG. 8 denotes an emergency unlocking member for manually rotating the lock pin 40 in the lock position to the unlock position via the torsion spring 44.

Referring to FIGS. 5 and 8, the lock pin 40 is disposed in the second set portion 25b of the bearing unit 24. The second set portion 25b is a recess that opens upward, and is adjacent to and in the inner side in the vehicle width direction Y of the first set portion 25a. The partition wall between the second set portion 25b and the first set portion 25a is partially cut out, and the inside of the second set portion 25b and the inside of the first set portion 25a spatially communicate with each other. On the rear side, in the vehicle length direction X, of the second set portion 25b, a shaft 25d that protrudes upward in the vehicle height direction Z and pivotally supports the lock pin 40 is provided. A sensor mounting portion 25e is provided in the inner side, in the vehicle width direction Y, of the second set portion 25b.

Referring to FIGS. 5, 10, and 11, the sleeve portion 40a fits to the shaft 25d of the second set portion 25b and is rotatable about a rotation axis B parallel to the rotation axis A of the pivoting part 36. The rotation axis A and the rotation axis B may not be parallel in a geometrically strict sense as long as the lock pin 40 can rotate and engage with the engagement groove 38 without hindrance.

The lock pin body 40b protrudes from the sleeve portion 40a to the front side in the vehicle length direction X toward the torsion spring 44 so as to be adjacent to the flange 37b of the spindle 37. The thickness of the lock pin body 40b in the vehicle height direction Z (direction in which the rotation axis B extends) is larger than the thickness of the flange 37b of the spindle 37.

The lower portion, in the vehicle height direction Z, of the lock pin body 40b forms an engagement protrusion 41 that engages with the engagement groove 38. The upper portion, in the vehicle height direction Z, of the lock pin body 40b forms a cam follower 42 that abuts the cam surface (cam) 53a of the input cam 52. That is, the engagement protrusion 41 and the cam follower 42 are integrally provided adjacent to each other in the vehicle height direction Z.

Here, the engagement groove 38 of the spindle 37 and the engagement protrusion 41 of the lock pin 40 will be described.

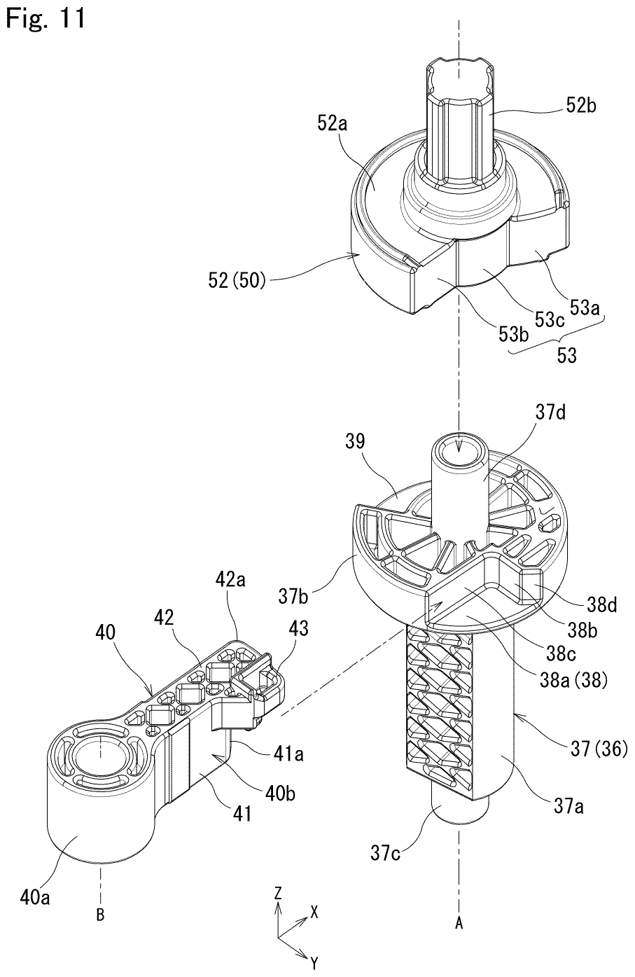

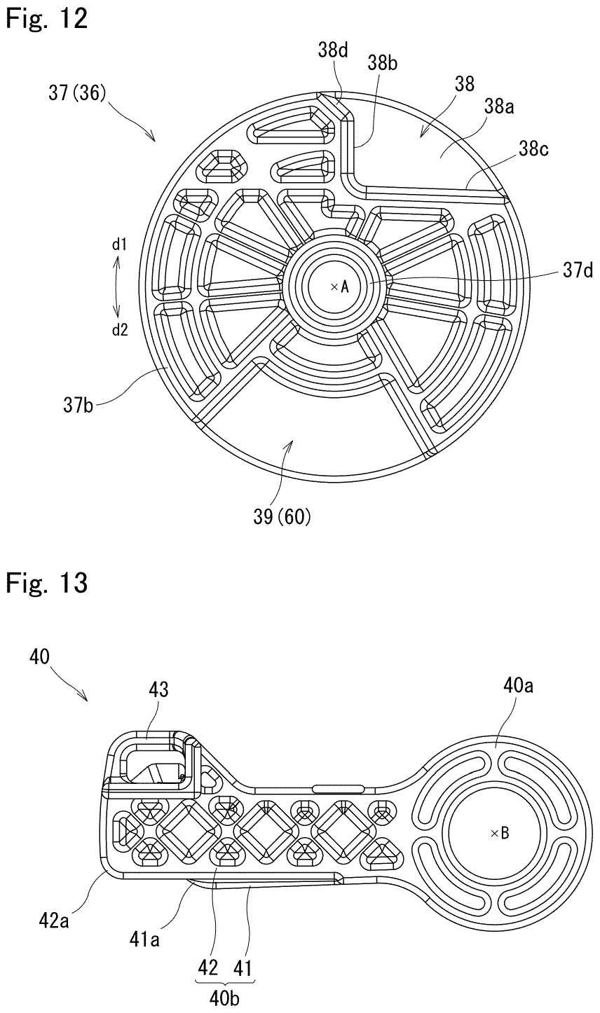

Referring to FIGS. 11 and 12, the engagement groove 38 of the spindle 37 is recessed inward from the outer circumferential surface of the flange 37b (pivoting part 36). The engagement groove 38 is defined by a base surface 38a, an abutting surface 38b, and a restricting surface 38c. A guide surface 38d is formed at an outer end of the abutting surface 38b of the engagement groove 38.

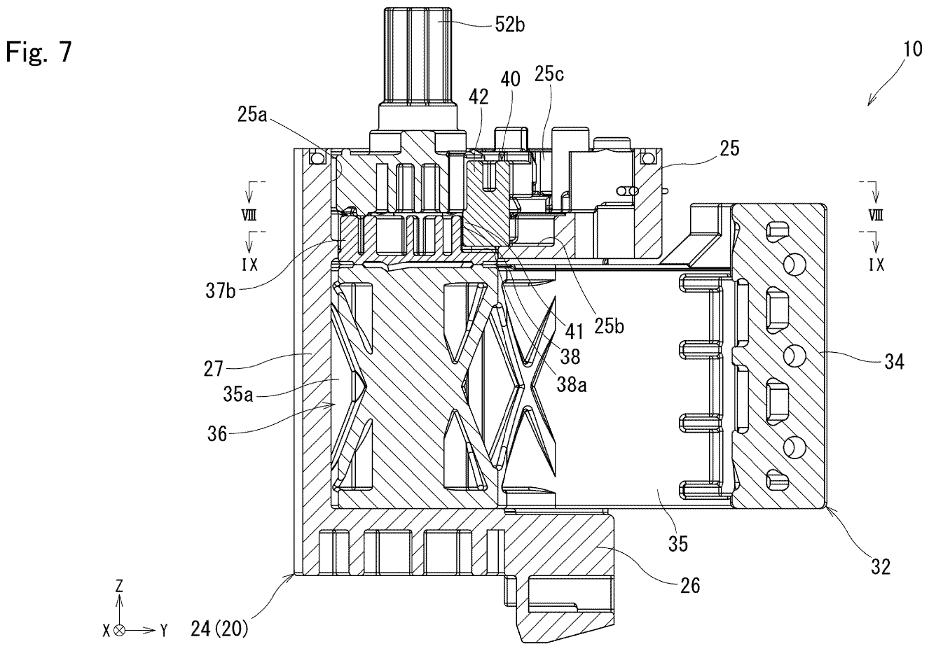

The base surface 38a has a flat annular sector shape extending in an XY plane. Referring to FIG. 7, in a state where the spindle 37 is disposed in the first set portion 25a, the base surface 38a is located below the lock pin 40 in the vehicle height direction Z.

Referring to FIGS. 11 and 12, the abutting surface 38b perpendicularly protrudes from the base surface 38a, forming a flat surface extending in the radial direction of the flange 37b. The direction in which the abutting surface 38b extends may not be a radial direction of the flange 37b in a geometrically strict sense as long as the lock pin 40 can engage and disengage without hindrance. Further, the abutting surface 38b may not be a flat surface in a geometrically strict sense as long as the lock pin 40 can engage and disengage without hindrance. Referring to FIG. 9, when the lid 30 in the closed state is accidentally operated to open-rotate the spindle 37 in the direction d1 via the arm 32, the abutting surface 38b abuts the engagement protrusion 41 of the lock pin 40 to restrict the rotation of the spindle 37. That is, the abutting surface 38b abuts the engagement protrusion 41 to prevent the rotation of the arm 32 from the retracted position to the advanced position and the rotation of the lid 30 from the closed position to the open position.

Referring to FIGS. 9 and 12, the restricting surface 38c is a flat surface that perpendicularly protrudes from the base surface 38a to extend in a direction intersecting a radial direction of the flange 37b. The restricting surface 38c extends along the engagement protrusion 41 in the lock position and restricts the lock pin 40 rotating toward the rotation axis A of the pivoting part 36. The angle between the restricting surface 38c and the abutting surface 38b is set to 90 degrees or more, preferably, to an angle larger than and close to 90 degrees (for example, 92 degrees).

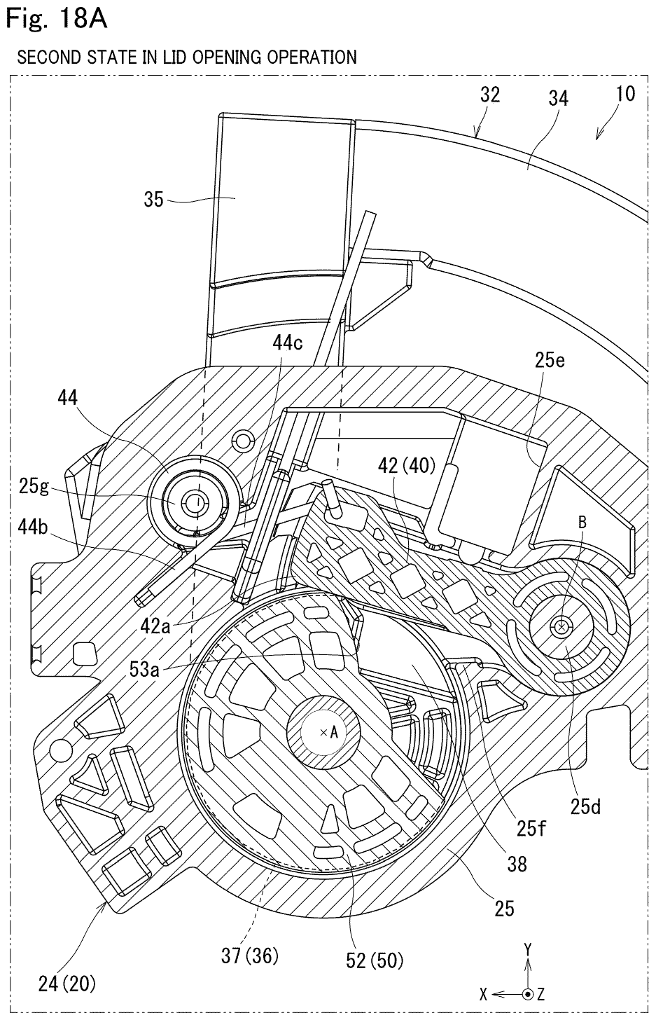

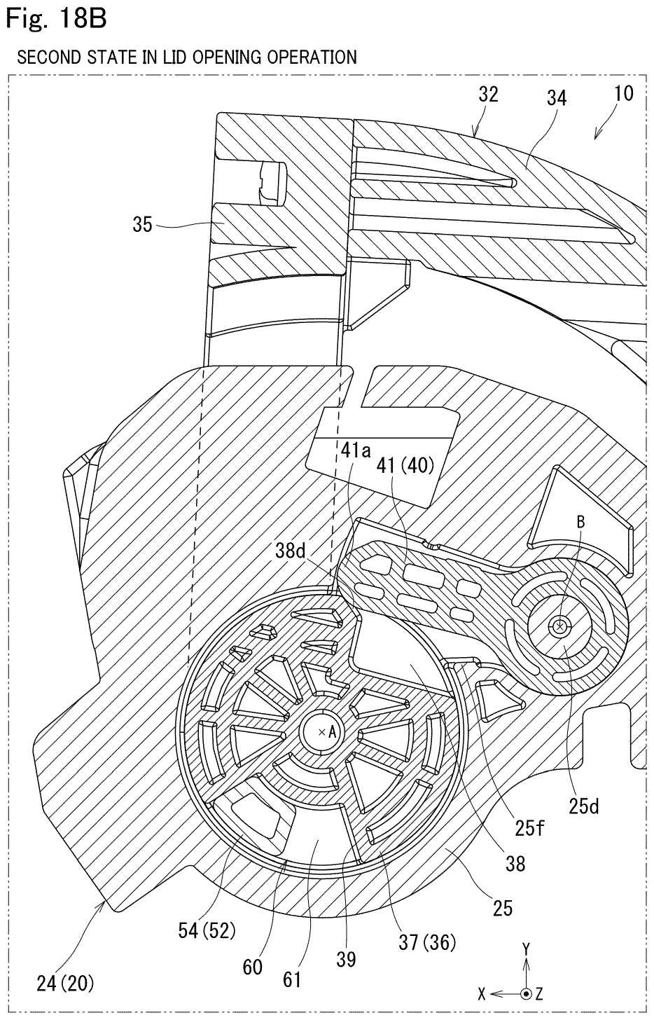

The guide surface 38d is provided at the outer end, in a radial direction of the flange 37b, of the abutting surface 38b, forming a flat surface inclined away from the restricting surface 38c. More specifically, the guide surface 38d is inclined in the direction d2, in which the spindle 37 is close-rotated, from the inner side to the outer side in a radial direction of the flange 37b. The guide surface 38d configured as described above rotates the lock pin 40 that has rotated from the lock position (see FIG. 9) toward the unlock position (see FIG. 18B) to the unlock position (see FIG. 19B).

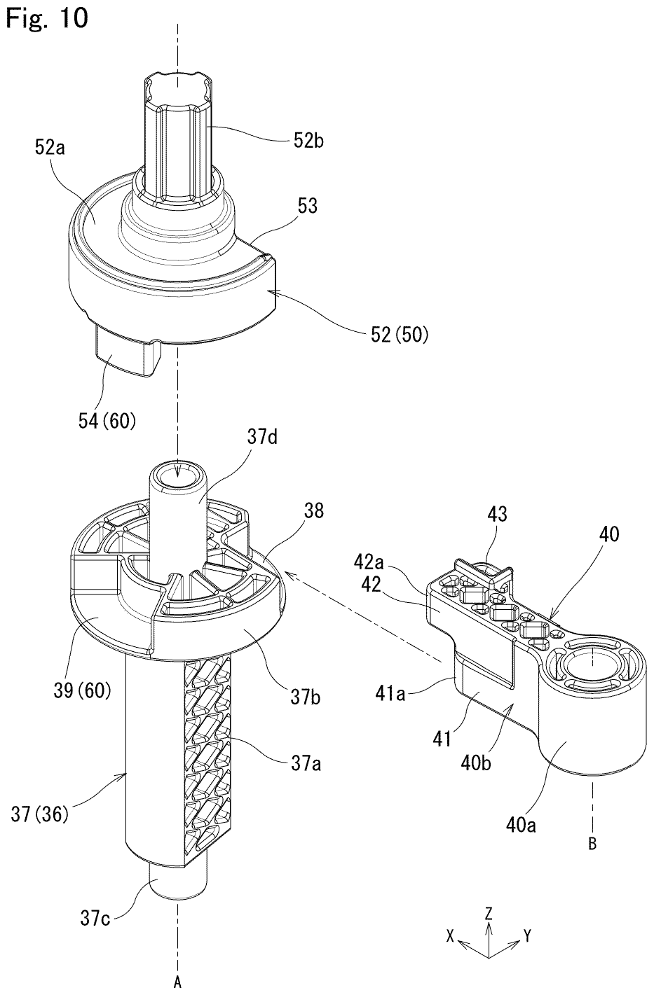

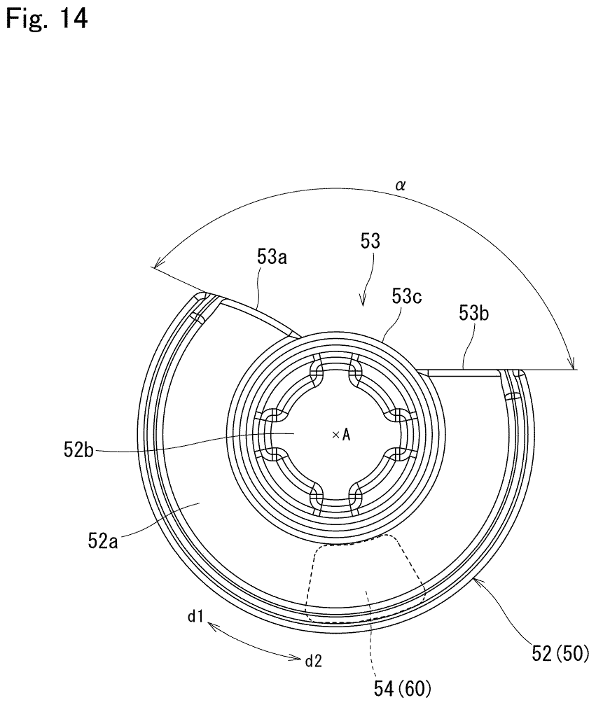

Referring to FIGS. 10 and 13, the engagement protrusion 41 of the lock pin 40 protrudes further toward the rotation axis A of the pivoting part 36 than the cam follower 42. That is, the width, in the circumferential direction around the rotation axis B, of the lock pin 40 of the engagement protrusion 41 is larger than the width of the cam follower 42. Referring to FIG. 9, a distal end 41a, on the opposite side of the sleeve portion 40a, of the engagement protrusion 41 is rounded to have an arcuate cross section. In a state where the arm 32 has rotated to the retracted position, the abutting surface 38b of the engagement groove 38 can abut and slide against the distal end 41a.

The lock pin 40 can be positioned in the lock position illustrated in FIGS. 8 and 9 and the unlock position illustrated in FIGS. 19A and 19B. The lock pin 40 in the lock position illustrated in FIGS. 8 and 9 locks the lid 30 in the closed position illustrated in FIG. 3 via the spindle 37 not to move. The lock pin 40 in the unlock position illustrated in FIGS. 19A and 19B unlocks the lid 30 via the spindle 37 to be openable. The lock pin 40 in the lock position is in a rotational angular position different from that of the lock pin 40 in the unlock position. The rotational angular position of the lock pin 40 is defined by the center line, regarding the width along the circumferential direction around the rotation axis B, of the engagement protrusion 41.

As illustrated in FIG. 9, the lock position of the lock pin 40 is set at a second rotational angular position where the engagement protrusion 41 has rotated toward the rotation axis A of the pivoting part 36 beyond a first rotational angular position where the engagement protrusion 41 extends in a direction perpendicular to the abutting surface 38b. As illustrated in FIG. 19B, the unlock position of the lock pin 40 is set at a rotational angular position where the engagement protrusion 41 abuts the outer periphery of the flange 37b of the spindle 37.

The first rotational angular position where the engagement protrusion 41 extends perpendicular to the abutting surface 38b is a boundary of the range in which abutment (pressing) of the abutting surface 38b with the engagement protrusion 41 can prevent the lock pin 40 from rotating toward the unlock position when the lid 30 is accidentally operated to open. The range from the first rotational angular position toward the rotation axis A including the second rotational angular position described above is an opening prevention range in which the lid 30 is prevented from being accidentally opened. When the abutting surface 38b presses the engagement protrusion 41 that has rotated to be in this range, the lock pin 40 rotates toward the lock position. However, the rotation of the lock pin 40 is restricted by abutting against the restricting surface 38c of the engagement groove 38. Thus, the abutment of the abutting surface 38b against the engagement protrusion 41 prevents the open-rotation of the spindle 37 in the direction d1. As a result, the lid 30 cannot rotate to the open position illustrated in FIG. 2, staying in the closed position illustrated in FIG. 3. Thus, the second rotational angular position where the engagement protrusion 41 has rotated toward the rotation axis A of the pivoting part 36 beyond the first rotational angular position where the engagement protrusion 41 extends in a direction perpendicular to the abutting surface 38b is set as the lock position of the lock pin 40. However, the position of the engagement protrusion 41 at the first rotational angular position may be set as the lock position of the lock pin 40.

Meanwhile, in a range from the first rotational angular position, where the engagement protrusion 41 extends in a direction perpendicular to the abutting surface 38b, toward the opposite side of the rotation axis A, accidental opening of the lid 30 cannot be prevented. When the abutting surface 38b presses the engagement protrusion 41 that has rotated into in this range, the lock pin 40 receives a force that rotates the lock pin 40 in a direction away from the rotation axis A of the pivoting part 36. This causes the lock pin 40 to rotate toward the unlock position illustrated in FIG. 19B, and the engagement protrusion 41 disengages from the engagement groove 38. As a result, the spindle 37 becomes rotatable in the direction d1. Thus, the unlock position of the lock pin 40 is set at the rotational angular position where the engagement protrusion 41 has rotated further remote from the rotation axis A of the pivoting part 36 than the first rotational angular position, where the engagement protrusion 41 extends in a direction perpendicular to the abutting surface 38b, to abut the outer periphery of the flange 37b of the spindle 37.

Referring to FIGS. 11 and 13, the cam follower 42 of the lock pin 40 includes an upper portion above, in the vehicle height direction Z, the engagement protrusion 41 of the lock pin body 40b. The cam follower 42 has a longer overall length than the engagement protrusion 41 to protrude further in the front side in the vehicle length direction X than the engagement protrusion 41. A round fillet 42a is provided at a corner of a distal end of the cam follower 42 on the opposite side of the sleeve portion 40a. The corner is the one closer to the rotation axis A of the pivoting part 36 (on the outer side in the vehicle width direction Y). When the lock pin 40 is in the lock position illustrated in FIGS. 8 and 9, the gap between the cam follower 42 and the cam surface 53a of the input cam 52 is larger than the gap between the engagement protrusion 41 and the abutting surface 38b of the spindle 37. Therefore, when the lid 30 is open-operated when the lock pin 40 is in the lock position, the abutting surface 38b abuts the engagement protrusion 41 by rotation of the spindle 37 but the cam surface 53a does not abut the cam follower 42. This prevents the lock pin 40 from rotating toward the unlock position via the input cam 51 by an accidental operation of the lid 30.

A frame-shaped mounting portion 43 to which the torsion spring 44 is attached is provided on the lock pin body 40b on the side opposite to the fillet 42a of the cam follower 42. The mounting portion 43 protrudes inward in the vehicle width direction Y.

Referring to FIGS. 5 and 8, the torsion spring 44 includes a wound portion 44a, a first arm 44b, and a second arm 44c, and is disposed in the third set portion 25c of the bearing unit 24. The third set portion 25c is adjacent to and in the inner side in the vehicle width direction Y of the first set portion 25a, and is adjacent to and in the front side in the vehicle length direction X of the second set portion 25b. The wound portion 44a is fitted to a protruding portion 25g protruding upward in the vehicle height direction Z, and is positioned in a first groove 25h surrounding the protruding portion 25g. The first arm 44b is positioned in a second groove 25i extending in a tangential direction of the first groove 25h. The partition wall between the third set portion 25c and the second set portion 25b is partially cut out, and the third set portion 25c and the second set portion 25b spatially communicate with each other. The second arm 44c protrudes into the second set portion 25b through the cutout in the partition wall, and is hooked on the mounting portion 43.

Referring to FIGS. 4 and 5, the drive mechanism 50 includes a single motor 41 disposed in the cover 28 and the input cam 52 disposed in the first set portion 25a of the bearing unit 24.

The motor 51 is a drive source capable of forward rotation and backward rotation, and performs both opening and closing of the lid 30 and rotation of the lock pin 40. The motor 51 rotates forward or backward by an electrically connected drive circuit (not illustrated) being controlled by an electronic control unit (ECU). The forward rotation of the motor 51 rotates the lock pin 40 in the lock position illustrated in FIGS. 8 and 9 to the unlock position illustrated in FIGS. 19A and 19B via the input cam 52 and the spindle 37, and rotates the arm 32 in the retracted position illustrated in FIG. 3 to the advanced position illustrated in FIG. 2 via the input cam 52 and the differential mechanism 60. The backward rotation of the motor 51 rotates the arm 32 in the advanced position illustrated in FIG. 2 to the retracted position illustrated in FIG. 3 via the input cam 52 and the differential mechanism 60. This allows rotation of the lock pin 40 from the unlock position illustrated in FIGS. 19A and 19B to the lock position illustrated in FIGS. 8 and 9 by the biasing force of the torsion spring 44.

Referring to FIGS. 5 and 6, the input cam 52 is a rotating body that is disposed in the first set portion 25a to be positioned above the flange 37b of the spindle 37 and rotates by the driving force received from the motor 51. The input cam 52 includes the cam surface (cam) 53a that transmits the driving force received from the motor 51 to the lock pin 40 and moves the lock pin 40 in the lock position illustrated in FIGS. 8 and 9 toward the unlock position illustrated in FIGS. 19A and 19B. In addition, the input cam 52 integrally includes a protruding portion 54 constituting the differential mechanism 60 that transmits the driving force received from the motor 51 to the spindle 37. The protruding portion 54 will be described in detail later.

Referring to FIGS. 10 and 11, the input cam 52 includes a main body 52a having an annular sector shape as viewed from the extending direction of the rotation axis A of the pivoting part 36, and a connecting portion 52b protruding from the center of the main body 52a. Referring to FIG. 4, the connecting portion 52b passes through the through hole 28b to protrude outside the cover 28, and is connected to the motor 51. The connecting portion 52b protrudes along the rotation axis A, has a non-circular cross section, and has a plurality of ribs radially protruding from the outer circumferential surface. However, the connecting portion 52b may be provided on the motor 51 to be connected to the input cam 52.

Referring to FIG. 6, the input cam 52 is provided with a shaft hole 52c. By fitting the shaft hole 52c to the shaft 37d of the spindle 37, the input cam 52 is pivotally supported on the flange 37b and can rotate about the rotation axis A of the pivoting part 36.

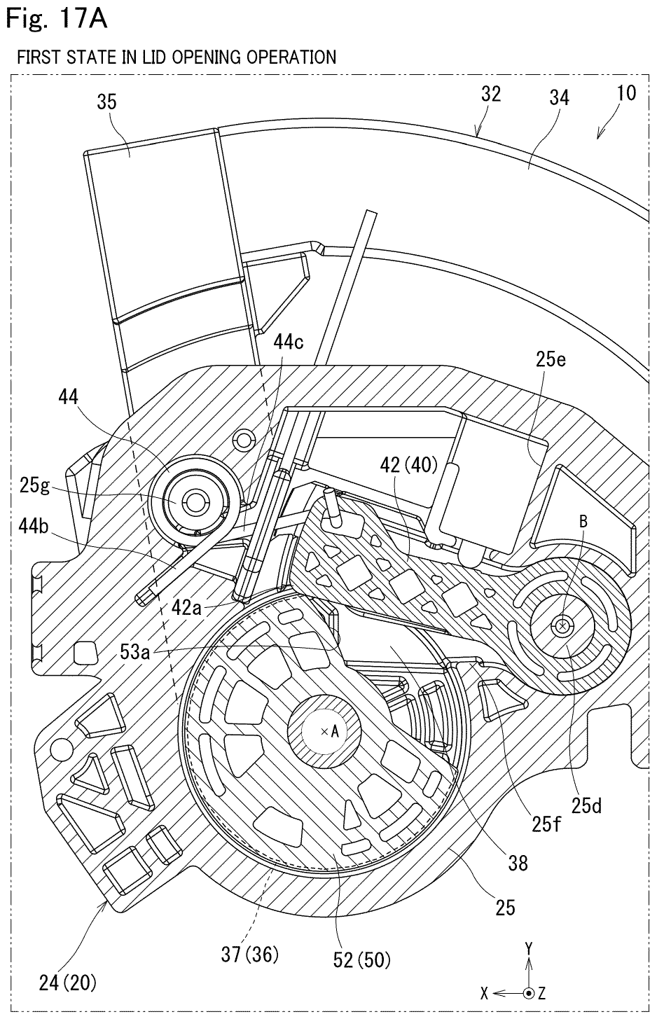

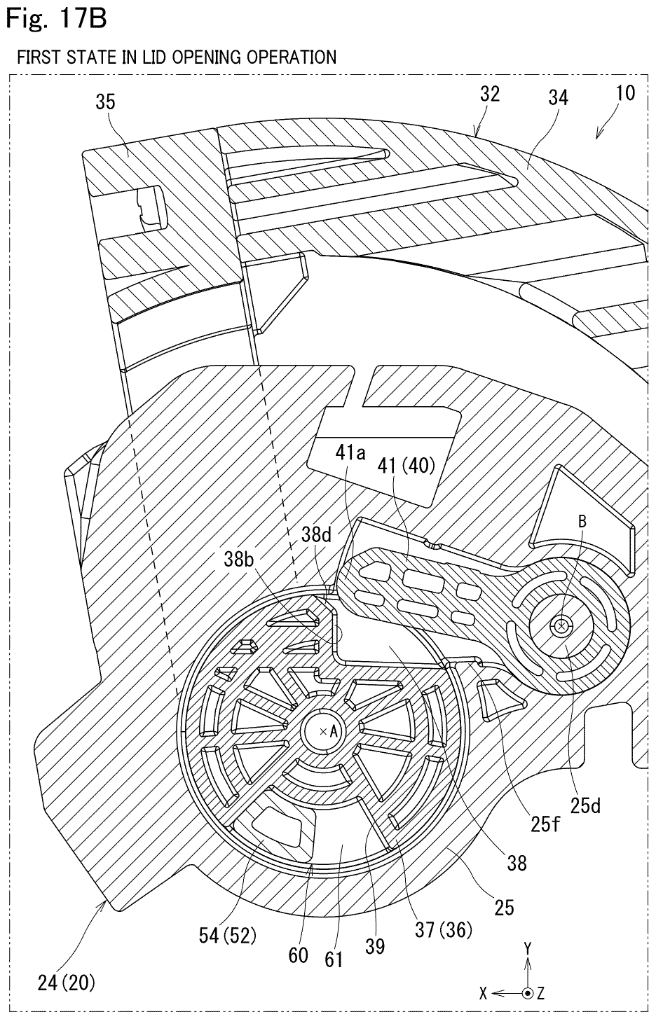

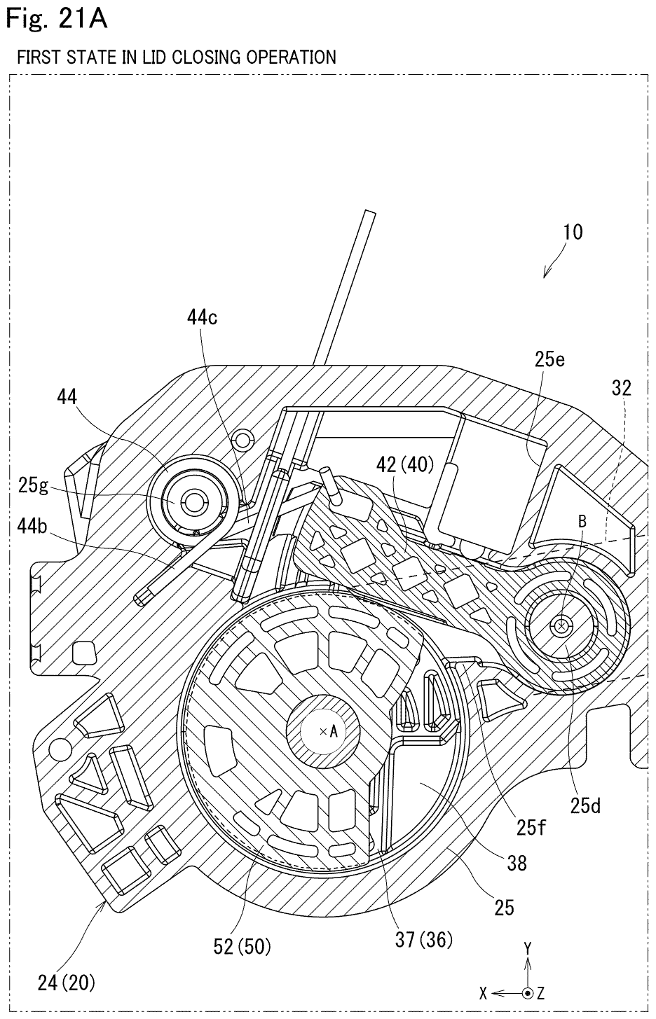

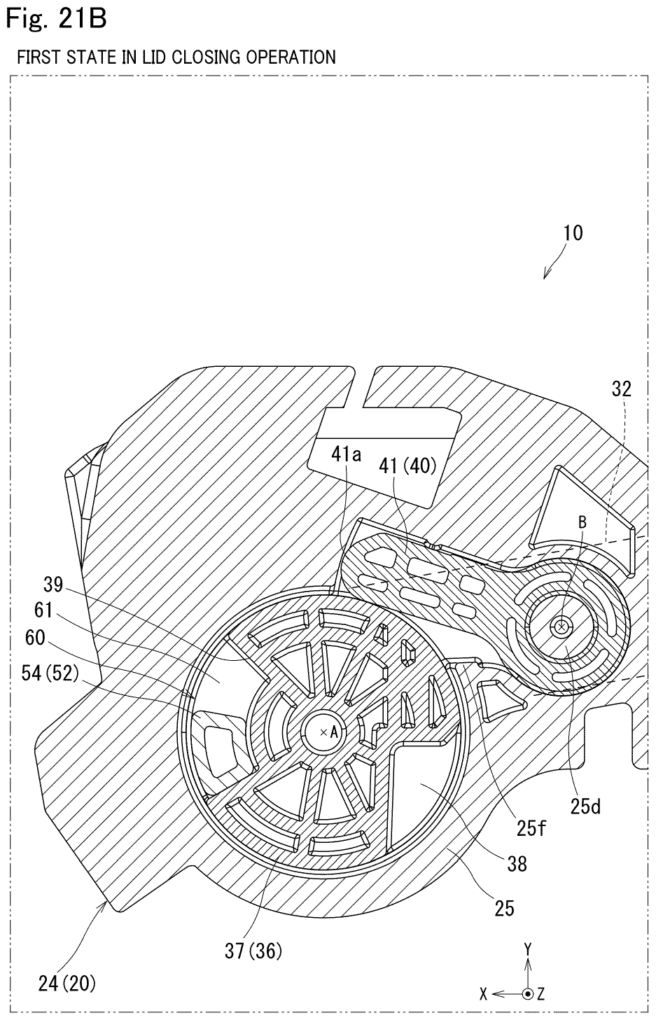

Referring to FIGS. 11 and 14, a cutout 53 is formed in the main body 52a to allow engagement of the engagement protrusion 41 with the engagement groove 38. The cutout 53 is recessed inward from the outer circumferential surface of the input cam 52 and extends in the vehicle height direction Z. The input cam 52 is disposed on the spindle 37 so as the cutout 53 to be located above the engagement groove 38. As viewed from the extending direction of the rotation axis A of the pivoting part 36, an angular range α of the cutout 53 about the rotation axis A of the pivoting part 36 has such a size that exposes the engagement groove 38. More specifically, the angular range α of the cutout 53 exposes the engagement groove 38 in the opening operation of moving the arm 32 in the retracted position to the advanced position as illustrated in FIG. 17A as well as in the closing operation of moving the arm 32 in the advanced position to the retracted position as illustrated in FIG. 21A.

One of wall surfaces defining the cutout 53 forms the cam surface (cam) 53a that transmits the rotational force of the input cam 52 to rotate the lock pin 40 in the lock position illustrated in FIGS. 8 and 9 toward the unlock position illustrated in FIGS. 18A and 18B when the arm 32 in the retracted position illustrated in FIG. 3 is moved to the advanced position illustrated in FIG. 2. Specifically, the cutout 53 is defined by the cam surface 53a, an opposing surface 53b that faces the cam surface 53a in the circumferential direction around the rotation axis A of the pivoting part 36, and an inner circumferential surface 53c that extends in the circumferential direction. The cam surface 53a is on the rear side in the direction d1 in which the input cam 52 open-rotates. The cam surface 53a bulges in an arc shape toward the opposing surface 53b, and rotates in conjunction with the input cam 52.

When the arm 32 in the retracted position illustrated in FIG. 3 is moved to the advanced position illustrated in FIG. 2, the lock pin 40 in the lock position illustrated in FIGS. 8 and 9 is rotated to the unlock position illustrated in FIGS. 19A and 19B by the cam surface 53a of the input cam 52 and the guide surface 38d of the spindle 37. Specifically, the cam surface 53a slides against the cam follower 42 to rotate the lock pin 40 in the lock position illustrated in FIGS. 8 and 9 toward the unlock position illustrated in FIGS. 17A and 17B. In this action, the cam surface 53a rotates the lock pin 40 into a range closer to the unlock position than the first rotational angular position where the engagement protrusion 41 perpendicularly extends from the abutting surface 38b. Subsequently, the engagement protrusion 41 slides against the guide surface 38d (see FIG. 18B) to rotate the lock pin 40 to the unlock position illustrated in FIGS. 19A and 19B.

Referring to FIGS. 5 and 10, the differential mechanism 60 includes the recessed portion 39 of the spindle 37 and the protruding portion 54 of the input cam 52 which start rotating the pivoting part 36 after a delay from the start of rotation of the input cam 52. Alternatively, the recessed portion 39 may be provided in the input cam 52, and the protruding portion 54 may be provided on the spindle 37.

The protruding portion 54 is provided on the outer periphery of the lower surface of the input cam 52 facing the spindle 37. As viewed from the extending direction of the rotation axis A of the pivoting part 36, the protruding portion 54 has an annular sector shape, and protrudes from the input cam 52 toward the spindle 37.

The recessed portion 39 is provided in the flange 37b of the spindle 37. The recessed portion 39 is an annular sector-shaped groove recessed inward from the outer circumferential surface of the flange 37b and has an upward opening facing the input cam 52. The protruding portion 54 is disposed in the recessed portion 39 (see FIG. 9).

Referring to FIG. 9, in the circumferential direction around the rotation axis A of the pivoting part 36, an angular range β of the protruding portion 54 is smaller than an angular range γ of the recessed portion 39. This creates a gap 61 of a difference between the angular ranges β and γ between the protruding portion 54 and the recessed portion 39 in the circumferential direction around the rotation axis A. The angular range (γ-β) of the gap 61 is a differential angular range for starting the rotation of the pivoting part 36 after a delay from the start of rotation of the input cam 52.

FIGS. 17A and 17B illustrate a state in which the input cam 52 illustrated in FIGS. 8 and 9 is rotated by the differential angular range (γ-β). Referring to FIGS. 8 and 9 and FIGS. 17A and 17B, the differential angular range (γ-β) is larger than the rotational angle by which the input cam 52 rotates to rotate the lock pin 40 in the lock position beyond the first rotational angular position toward the unlock position.

Accordingly, after the lock pin 40 in the lock position illustrated in FIGS. 8 and 9 has rotated beyond the first rotational angular position toward the unlock position illustrated in FIGS. 17A and 17B, the opposing surfaces of the protruding portion 54 and the recessed portion 39 abut each other and the spindle 37 starts to rotate. Then, while the guide surface 38d of the spindle 37 rotates the lock pin 40 to the unlock position (see FIG. 18B), the arm 32 in the retracted position illustrated in FIG. 3 can be rotated to the advanced position illustrated in FIG. 2.

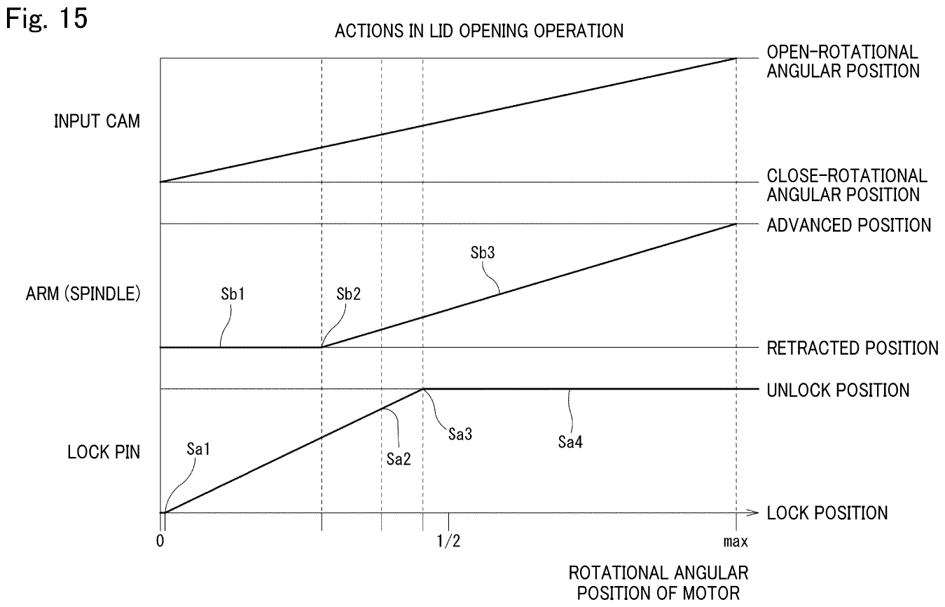

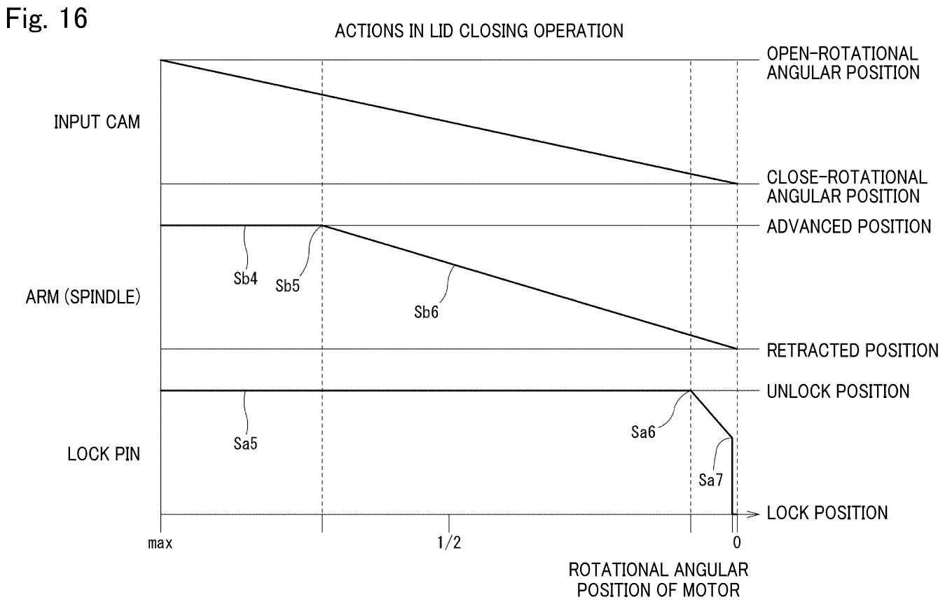

FIGS. 15 and 16 are charts showing the movement of the input cam 52, the spindle 37 (pivoting part 36), and the lock pin 40 with respect to the rotational angular position of the motor 51. FIG. 15 shows the opening operation of rotating the lid 30 in the closed position to the open position, and FIG. 16 shows the closing operation of rotating the lid 30 in the open position to the closed position.

The rotational angular range by which the cam follower 42 rotates by the cam surface 53a of the input cam 52, the rotational angular range by which the engagement protrusion 41 rotates by the guide surface 38d of the spindle 37, and the angular range (γ-β) of the gap 61 of the differential mechanism 60 are set so that the lid opening operation shown in FIG. 15 and the lid closing operation shown in FIG. 16 can be performed.

Hereinafter, the operation of the lid opening and closing device 10 will be described with reference to FIGS. 15 and 16.

Referring to FIG. 15, to rotate the lid 30 in the closed position illustrated in FIG. 3 to the open position illustrated in FIG. 2, the motor 51 forward-rotates from an initial rotational angular position (0) to a maximum rotational angular position (max). This causes the input cam 52 to open-rotate in the direction d1 from a close-rotational angular position illustrated in FIGS. 8 and 9 to an open-rotational angular position illustrated in FIGS. 20A and 20B. During this action, the arm 32 and the lock pin 40 operate as follows.

Since the cam surface 53a integrally rotates with the open rotating input cam 52, the lock pin 40 in the lock position illustrated in FIGS. 8 and 9 starts to move toward the unlock position after a delay time corresponding to the clearance between the cam surface 53a and the cam follower 42 (see Sal in FIG. 15). Since the rotational force of the input cam 52 is not transmitted to the spindle 37 (pivoting part 36) due to the gap 61 of the differential mechanism 60, the arm 32 does not rotate as indicated by Sb1 in FIG. 15.

As illustrated in FIGS. 17A and 17B, after the input cam 52 has rotated by an angle corresponding to the gap 61 of the differential mechanism 60 (differential angular range: γ-β), the opposing surfaces of the recessed portion 39 and the protruding portion 54 abut each other (see Sb2 in FIG. 15). Thereafter, the rotational force of the input cam 52 is transmitted to rotate the spindle 37, and the arm 32 in the retracted position starts to rotate toward the advanced position (see Sb3 in FIG. 15). During this action, the lock pin 40 continues to rotate toward the unlock position by the cam surface 53a sliding against the cam follower 42.

As the spindle 37 rotates, following the sliding contact between the cam surface 53a and the cam follower 42, the engagement protrusion 41 slides against the guide surface 38d as illustrated in FIGS. 18A and 18B (see Sa2 in FIG. 15). This causes the lock pin 40 to subsequently rotate toward the unlock position. Thereafter, as illustrated in FIGS. 19A and 19B, the spindle 37 rotates to a position where the outer end of the guide surface 38d comes into sliding contact with the engagement protrusion 41, thereby rotating the lock pin 40 to the unlock position (see Sa3 in FIG. 15). The lock pin 40 is now pressed against the outer circumferential surface of the flange 37b of the spindle 37 by the biasing force of the torsion spring 44, and is held in the unlock position (see Sa4 of FIG. 15).

Rotation of the input cam 52 to the open-rotational angular position rotates the arm 32 to the advanced position via the spindle 37 as illustrated in FIGS. 20A and 20B. Consequently, the lid 30 is rotated to the open position. In this state, the lock pin 40 is pressed against the outer circumferential surface of the flange 37b by the biasing force of the torsion spring 44, and is kept in the unlock position.

Referring to FIG. 16, to rotate the lid 30 in the open position illustrated in FIG. 2 to the closed position illustrated in FIG. 3, the motor 51 backward-rotates from the maximum rotational angular position (max) to the initial rotational angular position (0). This causes the input cam 52 to close-rotate in the direction d2 from the open-rotational angular position illustrated in FIGS. 20A and 20B to the close-rotational angular position illustrated in FIGS. 8 and 9. During this action, the arm 32 and the lock pin 40 operate as follows.

The cam surface 53a integrally rotates with the close-rotating input cam 52, but the lock pin 40 is held in the unlock position without rotating since the cam surface 53a is at a rotational angular position away from the cam follower 42 (see Sa5 in FIG. 16). Since the rotational force of the input cam 52 is not transmitted to the spindle 37 (pivoting part 36) due to the gap 61 of the differential mechanism 60, the arm 32 also does not rotate as indicated by Sb4 in FIG. 16.

As illustrated in FIGS. 21A and 21B, after the input cam 52 has rotated by an angle corresponding to the gap 61 of the differential mechanism 60 (differential angular range: γ-β), the opposing surfaces of the recessed portion 39 and the protruding portion 54 abut each other (see Sb5 in FIG. 16). Thereafter, the rotational force of the input cam 52 is transmitted to rotate the spindle 37, and the arm 32 in the advanced position illustrated in FIG. 2 starts to rotate toward the retracted position illustrated in FIG. 3 (see Sb6 in FIG. 16). During this action, the lock pin 40 is held in the unlock position without rotating.

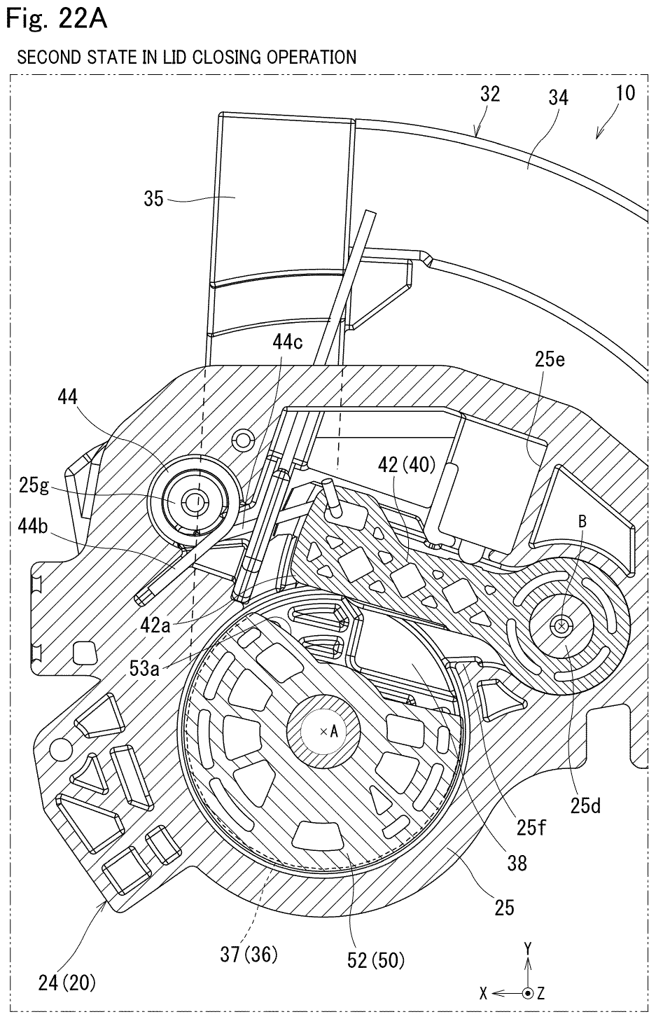

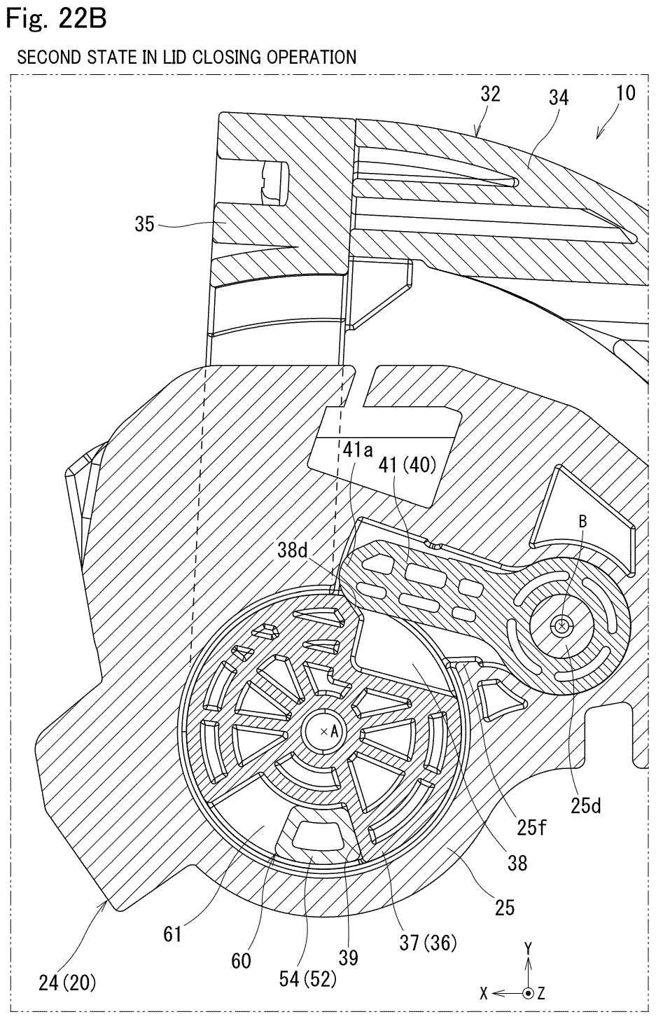

As the spindle 37 rotates, the engagement protrusion 41 slides against the guide surface 38d as illustrated in FIGS. 22A and 22B (see Sa6 in FIG. 16). The lock pin 40 in the unlock position starts to rotate toward the lock position by the biasing force of the torsion spring 44. The rotation of the input cam 52 to the close-rotational angular position rotates the spindle 37 to a position where the engagement protrusion 41 comes into sliding contact with the abutting surface 38b (see Sa7 in FIG. 16). As a result, as illustrated in FIGS. 8 and 9, the lock pin 40 rotates to the lock position and stops by abutting the stopper 25f. The rotation of the arm 32 via the spindle 37 to the retracted position rotates the lid 30 to the closed position as illustrated in FIG. 3.

As described above, by setting the rotational angular range by which the cam follower 42 (lock pin 40) rotates by the cam surface 53a of the input cam 52, the rotational angular range by which the engagement protrusion 41 (lock pin 40) rotates by the guide surface 38d of the spindle 37, and the angular range (γ-β) of the gap 61 of the differential mechanism 60 so that the lid opening operation illustrated in FIG. 15 and the lid closing operation illustrated in FIG. 16 can be performed, locking and unlocking of the arm 32 (lid 30) by the lock pin 40 can be performed without hindering the arm 32 rotating between the advanced position illustrated in FIG. 2 and the retracted position illustrated in FIG. 3 by a single motor 51.

The lid opening and closing device 10 configured as described above has the following features.

The lid 30 can be automatically opened and closed via the arm 32, since there is provided the input cam 52 that transmits the driving force of the motor 51 to the pivoting part 36 to move the arm 32 to the retracted position and the advanced position. In addition, the lock pin 40 rotatable between the lock position where the lock pin 40 is engaging with the engagement groove 38 of the pivoting part 36 and the unlock position where the lock pin 40 is disengaged from the engagement groove 38 when the arm 32 is in the retracted position is provided, so that the lid 30 in the closed state can be locked via the arm 32. Furthermore, there is provided the cam surface 53a that transmits the rotational force of the input cam 52 to rotate the lock pin 40 in the lock position toward the unlock position when the arm 32 in the retracted position is moved toward the advanced position, so that locking by the lock pin 40 can be cancelled in the opening operation of the lid 30. As described above, since automatic opening and closing of the lid 30 and locking of the lid 30 by the lock pin 40 can both be performed by a single motor 51, an increase in size and cost of the lid opening and closing device 10 is suppressed as compared with the case where two drive sources are mounted, and security can be improved.

The cam surface 53a is a wall surface of the cutout 53 in the input cam 52, and the lock pin 40 includes the engagement protrusion 41 that engages with the engagement groove 38 and the cam follower 42 that abuts the cam surface 53a. This allows densely arranging the cam surface 53a and the input cam 52 around the pivoting part 36 to downsize the lid opening and closing device 10.

The engagement groove 38 has an abutting surface 38b extending in a radial direction of the pivoting part 36, and the engagement protrusion 41 has the distal end 41a extending in a direction intersecting the abutting surface 38b and having an arcuate cross section to slide against the abutting surface 38b. Therefore, the locking and unlocking operations of the lock pin 40 with the engagement groove 38 can be performed smoothly.

When the lock pin 40 is in the lock position, the engagement protrusion 41 is in the first rotational angular position in which the engagement protrusion 41 extends in a direction perpendicular to the abutting surface 38b, or at the second rotational angular position where the lock pin 40 has rotated toward the rotation axis A of the pivoting part 36 beyond the first rotational angular position. Thus, when the lid 30 in the closed state is accidentally operated in the opening direction, the movement of the arm 32 from the retracted position toward the advanced position can be reliably prevented by the abutting surface 38b of the engagement groove 38 abutting the lock pin 40. The force applied to the lock pin 40 by the movement of the arm 32 acts not in a direction intersecting the engagement protrusion 41, which is the direction of bending the engagement protrusion 41, but in the compressive direction, which is the extending direction of the engagement protrusion 41. Thus, the warpage of the accidentally operated lock pin 40 can be reduced, and furthermore the lock pin 40 can be used in a more rigid manner. Accordingly, the lid 30 can be held in the closed state with a greatly enhanced force as compared with the case where the lock pin 40 works like a cantilever to which a force is applied in a direction intersecting the extending direction of the lock pin 40.

The stopper that restricts the lock pin 40 rotating beyond the lock position is provided. This enables holding the lock pin 40 in the lock position when the lid 30 in the closed state is accidentally operated to the open direction, and the locking strength of the lid 30 can be enhanced.

The engagement protrusion 41 protrudes toward the rotation axis A of the pivoting part 36 further than the cam follower 42. Accordingly, after the lock pin 40 has rotated from the lock position toward the unlock position by the cam follower 42 sliding against the cam surface 53a, the lock pin 40 subsequently rotates to the unlock position by the sliding contact between the engagement protrusion 41 and the outer end of the engagement groove 38, and is held in the unlock position by abutting with the pivoting part 36. Thus, unintended movement of the lock pin 40 to the lock position can be reliably prevented.

The differential mechanism 60 has the protruding portion 54 provided on one of the pivoting part 36 and the input cam 52 and the recessed portion 39 provided on the other one, and the gap 61 of the predetermined differential angular range (γ-β) in the circumferential direction between the protruding portion 54 and the recessed portion 39. Therefore, the automatic opening and closing and locking of the lid 30 can be performed by a single motor 51 without hindering opening and closing of the lid 30 by the lock pin 40.

The base 20 is provided with the first set portion 25a in which the input cam 52 is disposed and the second set portion 25b in which the lock pin 40 is disposed, and the first set portion 25a and the second set portion 25b are covered by the cover 28. Thus, adherence of water droplets, dust, or the like to the pivoting part 36, the input cam 52 including the cam surface 53a, and the lock pin 40 can be prevented. Accordingly, happening of malfunction of the arm 32, the input cam 52 including the cam surface 53a, and the lock pin 40 can be suppressed.

The torsion spring 44 that biases the lock pin 40 in the unlock position toward the lock position is provided. Thus, by moving the arm 32 in the advanced position toward the retracted position, the lock pin 40 in the unlock position can be reliably rotated to the lock position.

The present invention is not limited to the configuration of the above embodiment, and various modifications can be made.

For example, the lid 30 may be rotatable in the vertical direction about a rotation axis extending in the vehicle length direction X.

The differential mechanism 60 can be changed as necessary as long as it has a configuration (structure) capable of starting the rotation of the arm 32 after moving the lock pin 40 in the lock position to the unlock position.

The first arm 34 may be formed separately from the lid 30, or may be integrally formed with the second arm 35.

### REFERENCE SIGNS LIST

1 side panel (panel)
2 receiving port
10 lid opening and closing device
15 power supply connector (receiving unit)
15a connecting portion
20 base
21 base body
21a insertion hole
21b opening
22 mounting portion
22a recessed portion
22b mounting port
23 sealing member
24 bearing unit
25 end wall part
25a first set portion
25b second set portion
25c third set portion
25d shaft
25e sensor mounting portion
25f stopper
25g positioning projection
25h first groove
25i second groove
26 end wall part
26a shaft hole
27 side wall part
28 cover
28a mounting piece
28b through hole
30 lid
30a protruding portion
31 sealing member
32 arm
34 first arm
34a continuous portion
35 second arm
35a sleeve portion
35b mounting hole
36 pivoting part
37 spindle
37a mounting portion
37b flange 37c shaft 37d shaft
38 engagement groove (engagement portion)
38a base surface
38b abutting surface
38c restricting surface
38d guide surface
39 recessed portion
40 lock pin (locking member)
40a sleeve portion
40b lock pin body
41 engagement protrusion
41a distal end
42 cam follower
42a fillet
43 mounting portion
44 torsion spring (biasing member)
44a wound portion
44b first arm
44c second arm
45 wire
50 drive mechanism
51 motor
52 input cam (rotating body)
52a main body
52b connecting portion
52c shaft hole
53 cutout
53a cam surface (cam)
53b opposing surface
53c inner circumferential surface
54 protruding portion
60 differential mechanism
61 gap
α cam angular range
β projection angular range of differential mechanism
γ recessed portion angular range of differential mechanism

1. A lid opening and closing device comprising:
a base disposed in an inner side of a receiving port of a panel;
a lid that openably close the receiving port;
an arm including a pivoting part on one end side of the arm and pivotally supported by the base, a continuous portion on another end side continuous with the lid, and an engagement portion provided to the pivoting part, the arm being movable between a retracted position where the arm is retracted within the panel to close the receiving port by the lid and an advanced position where the arm is protruding out through the panel to open the receiving port;
a rotating body that transmits a driving force received from a drive source to the pivoting part to move the arm between the retracted position and the advanced position;
a locking member pivotally supported by the base to be adjacent to the pivoting part, the locking member being rotatable about a rotation axis extending along a rotation axis of the pivoting part between a lock position in which the locking member is engaged with the engagement portion and an unlock position in which the locking member is disengaged from the engagement portion when the arm is in the retracted position;
a cam that is rotatable in conjunction with the rotating body and transmits a rotational force of the rotating body to rotate the locking member in the lock position toward the unlock position when the arm in the retracted position is moved to the advanced position; and
a differential mechanism that starts rotation of the pivoting part after a delay from start of rotation of the rotating body when the arm in the retracted position is moved to the advanced position.

2. The lid opening and closing device according to claim 1, wherein
the rotating body is disposed along the rotation axis of the pivoting part to be adjacent to the pivoting part,
the rotating body is provided with a cutout recessed inward from an outer circumferential surface of the rotating body and having an angular range that exposes the engagement portion as viewed from a direction in which the rotation axis of the pivoting part extends,
the cam is one of a pair of wall surfaces of the cutout, the wall surfaces facing each other in a circumferential direction around the rotation axis of the pivoting part, and
the locking member includes an engagement protrusion engageable with the engagement portion, and a cam follower provided along the rotation axis of the pivoting part and adjacent to the engagement protrusion to abut the cam.

3. The lid opening and closing device according to claim 2, wherein
the pivoting part has a circular shape as viewed from the direction in which the rotation axis of the pivoting part extends,
the engagement portion has a groove shape recessed inward from an outer circumferential surface of the pivoting part and has an abutting surface extending in a radial direction of the pivoting part, and
the engagement protrusion has a distal end having an arcuate cross section which the abutting surface abuts, the engagement protrusion extending in a direction intersecting the abutting surface when the locking member is in the lock position.

4. The lid opening and closing device according to claim 3, wherein when the locking member is in the lock position, the engagement protrusion is in a first rotational angular position in which the engagement protrusion extends in a direction perpendicular to the abutting surface or in a second rotational angular position where the locking member has rotated toward the rotation axis of the pivoting part beyond the first rotational angular position.

5. The lid opening and closing device according to claim 4, further comprising a stopper that restricts the locking member rotating beyond the lock position.

6. The lid opening and closing device according to claim 2, wherein
the engagement protrusion protrudes toward the rotation axis of the pivoting part further than the cam follower as viewed from the direction in which the rotation axis of the pivoting part extends, and
when the arm in the retracted position is moved to the advanced position, the locking member is rotated from the lock position toward the unlock position by sliding contact between the cam follower and the cam, and is subsequently rotated to the unlock position by sliding contact between the engagement protrusion and an outer end of the engagement portion.

7. The lid opening and closing device according to claim 1, wherein
the differential mechanism includes
a protruding portion provided to one of the pivoting part and the rotating body, and
a recessed portion provided to another one of the pivoting part and the rotating body, the protruding portion being disposed in the recessed portion,
an angular range of the protruding portion about the rotation axis of the pivoting part is smaller than an angular range of the recessed portion about the rotation axis of the pivoting part,
a gap having a predetermined differential angular range is present between the protruding portion and the recessed portion in a circumferential direction around the rotation axis of the pivoting part, and
rotation of the rotating body causes opposing surfaces of the protruding portion and the recessed portion in the circumferential direction to abut and press each other to rotate the pivoting part.

8. The lid opening and closing device according to claim 1, wherein
the base includes a first set portion in which the rotating body is rotatably disposed, and a second set portion that communicates with the first set portion and in which the locking member is rotatably disposed, and
the first set portion and the second set portion are covered by a cover having a through hole through which a connecting portion connecting the drive source to the rotating body passes.

9. The lid opening and closing device according to claim 1, further comprising a biasing member that biases the locking member in the unlock position toward the lock position.
